(19) United States
(12) Patent Application Publication
(10) Pub. No.: US 2020/0162267 A1
(43) Pub. Date: May 21, 2020

(54) SIGNATURE GENERATING METHOD, AND SIGNATURE TEMPLATE SHARING METHOD AND DEVICE

(71) Applicant: Alibaba Group Holding Limited, Grand Cayman (KY)

(72) Inventors: Jingchang Chen, Zhejiang (CN); Zhiyong She, Zhejiang (CN); Yiran Wang, Zhejiang (CN)

(21) Appl. No.: 16/752,463

(22) Filed: Jan. 24, 2020

Related U.S. Application Data
(63) Continuation of application No. PCT/CN2018/095604, filed on Jul. 13, 2018.

(30) Foreign Application Priority Data
Jul. 25, 2017 (CN) 201710610884.6

(51) Int. Cl. H04L 9/32; G06F 21/32; G06K 9/00; G06F 21/64

(52) U.S. Cl. CPC H04L 9/3247; G06F 21/64; G06K 9/00167; G06F 21/32

(57) ABSTRACT

A method including acquiring a signature template used by a user; and determining, according to contact information of the user, information content corresponding to an information item comprised in the signature template to generate a signature of the user. When the information content corresponding to the information item in the contact information of the user is changed, the signature of the user may be updated according to the changed contact information, so that information synchronization may be automatically maintained between information content in the signature and the contact information without the need of regenerating the signature by the user, which helps to simplify the operation of the user

### CROSS REFERENCE TO RELATED PATENT APPLICATIONS

This application claims priority to and is a continuation of PCT Patent Application No. PCT/CN2018/095604, filed on 13 Jul. 2018 and entitled “SIGNATURE GENERATING METHOD, AND METHOD AND DEVICE SIGNATURE TEMPLATE SHARING,” which claims priority to Chinese Patent Application No. 201710610884.6, filed on 25 Jul. 2017 and entitled “SIGNATURE GENERATING METHOD, AND METHOD AND DEVICE SIGNATURE TEMPLATE SHARING,” which are incorporated herein by reference in their entirety.

### TECHNICAL FIELD

One or more example embodiments of this disclosure relate to the field of communication technologies, and, more particularly, to a signature generating method, and a signature template sharing method and device.

### BACKGROUND

In conventional techniques, mobile group office platforms are increasingly widely used in office processes of enterprises, educational institutions, government agencies, and other groups. Such platforms may not only improve the communication efficiency between users and reduce communication costs, but also effectively improve users' event processing efficiency and office efficiency.

A user may configure his/her own signature in a mobile group office platform, and each time the user sends a message (such as a communication message or a comment message), the signature may be automatically added to the end of the message, instead of being manually input by the user each time, thereby simplifying user operations and improving communication efficiency.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The signature generating methods, and signature template sharing methods and devices are provided in one or more example embodiments of this disclosure.

One or more example embodiments of this disclosure provide the following technical solutions.

According to one or more example embodiments of this disclosure, a signature generating method is provided, comprising:

acquiring a signature template used by a user; and

determining, according to contact information of the user, information content corresponding to an information item comprised in the signature template to generate a signature of the user.

According to one or more example embodiments of this disclosure, a signature generating method is provided, comprising:

acquiring, according to a group to which a user belongs, a unified signature template of the group; and

generating a signature of the user according to the unified signature template.

According to one or more example embodiments of this disclosure, a signature generating method is provided, comprising:

acquiring alternative signature templates applicable to a user; and

selecting at least one signature template from the alternative signature templates to generate a signature of the user according to the selected signature template.

According to one or more example embodiments of this disclosure, a signature generating method is provided, comprising:

presenting alternative signature templates applicable to a user;

presenting preview information of a signature of the user according to information items included in the alternative signature templates and contact information of the user; and

determining a signature template selected by the user from the alternative signature templates for generating the signature of the user according to the selected signature template and the contact information of the user.

According to one or more example embodiments of this disclosure, a signature generating method is provided, comprising:

acquiring alternative signature templates applicable to a group; and

selecting at least one signature template from the alternative signature templates to use the selected signature template as a unified template for group members of the group, the unified template being configured to generate signatures of the group members.

According to one or more example embodiments of this disclosure, a signature template sharing method is provided, comprising:

determining a signature template used by a group; and

sharing the signature template to another group to generate a corresponding signature by a group member in the another group according to the signature template.

According to one or more example embodiments of this disclosure, a signature generating device is provided, comprising:

a first acquisition unit configured to acquire a signature template used by a user; and

a first determining unit configured to determine, according to contact information of the user, information content corresponding to an information item comprised in the signature template to generate a signature of the user.

According to one or more example embodiments of this disclosure, a signature generating device is provided, comprising:

a second acquisition unit configured to acquire, according to a group to which a user belongs, a unified signature template of the group; and

a generation unit configured to generate a signature of the user according to the unified signature template.

According to one or more example embodiments of this disclosure, a signature generating device is provided, comprising:

a third acquisition module configured to acquire alternative signature templates applicable to a user; and

a first selection module configured to select at least one signature template from the alternative signature templates to generate a signature of the user according to the selected signature template.

According to one or more example embodiments of this disclosure, a signature generating device is provided, comprising:

a presentation unit configured to present alternative signature templates applicable to a user;

a preview unit configured to present preview information of a signature of the user according to information items included in the alternative signature templates and contact information of the user; and a second determining unit configured to determine a signature template selected by the user from the alternative signature templates to generate the signature of the user according to the selected signature template and the contact information of the user.

According to one or more example embodiments of this disclosure, a signature generating device is provided, comprising:

a fourth acquisition unit configured to acquire alternative signature templates applicable to a group; and

a second selection unit configured to select at least one signature template from the alternative signature templates to use the selected signature template as a unified template for group members of the group, the unified template being configured to generate signatures of the group members.

According to one or more example embodiments of this disclosure, a signature template sharing device is provided, comprising:

a fourth determining unit configured to determine a signature template used by a group;

and a sharing unit configured to share the signature template to another group to generate a corresponding signature by a group member in the another group according to the signature template.

For example, in a large enterprise that has many employees, there is a need to generate a signature for each employee based on the group or department that the user belongs. It is technically impossible for the HR department to generate the signature for each user manually. The user may use a single personal computer (PC) to generate the signature by himself/herself. However, there is no guarantee of uniformity or consistency among the signatures of multiple users. Thus, there is a technical challenge to generate the signatures of the users uniformly and flexibly based on a fast deployment. Such fast deployment is a unique challenge in the Internet era. For example, the techniques of the present disclosure use clouding computing technology to quickly generate the signature templates and user signatures based on the templates uniformly and flexibly, which is an improvement to the conventional techniques that allow the user to manually input his/her signature on a single PC.

As shown from the above technical solutions, in one or more example embodiments of this disclosure, by providing one or more alternative signature templates that are applicable to different groups, an operation of configuring a signature for a user is simplified by using the technical solutions, thus improving the efficiency of configuring the signature.

### BRIEF DESCRIPTION OF THE DRAWINGS

The accompanying drawings described here are used to provide further understanding about the present disclosure and constitute a part of the present application. Example embodiments of the present disclosure and illustration thereof are used to explain the present disclosure, and do not pose any improper limitation to the present disclosure.

FIG. 1 is a schematic architectural diagram of a communication system according to an example embodiment.

FIG. 2A is a flowchart of a signature generating method according to an example embodiment.

FIG. 2B is a flowchart of another signature generating method according to an example embodiment.

FIG. 3A is a flowchart of still another signature generating method according to an example embodiment.

FIG. 3B is a flowchart of still another signature generating method according to an example embodiment.

FIG. 4 is a flowchart of still another signature generating method according to an example embodiment.

FIG. 5 is a schematic architectural diagram of a signature template sharing system according to an example embodiment of this application.

FIG. 6 is a flowchart of a signature template sharing method according to an example embodiment.

FIG. 7 is a schematic diagram of a unified signature setting interface of an enterprise instant messaging application client terminal 1 according to an example embodiment.

FIG. 8 is a schematic diagram of a signature template setting interface of an enterprise instant messaging application client terminal 1 according to an example embodiment.

FIG. 9 and FIG. 10 are schematic diagrams of a preview signature of an enterprise instant messaging application client terminal 1 according to an example embodiment.

FIG. 11 is a schematic diagram of addition of group information of an enterprise instant messaging application client terminal 1 according to an example embodiment.

FIG. 12 is a schematic diagram of an enterprise certification prompt window of an enterprise instant messaging application client terminal 1 according to an example embodiment.

FIG. 13 is a schematic diagram of selection of a linked enterprise of an enterprise instant messaging application client terminal 1 according to an example embodiment.

FIG. 14 is another schematic diagram of a preview signature of an enterprise instant messaging application client terminal 1 according to an example embodiment.

FIG. 15 and FIG. 16 are schematic diagrams of editing of a signature template of an enterprise instant messaging application client terminal 1 according to an example embodiment.

FIG. 17 is a schematic diagram of setting of a unified group signature of an enterprise instant messaging application client terminal 1 according to an example embodiment.

FIG. 18 is another schematic diagram of a unified signature setting interface of an enterprise instant messaging application client terminal 1 according to an example embodiment.

FIG. 19 is a schematic diagram of a personal signature setting interface of an enterprise instant messaging application client terminal 2 according to an example embodiment.

FIG. 20 is a schematic diagram of a new e-mail interface of an enterprise instant messaging application client terminal 2 according to an example embodiment.

FIG. 21 is a schematic diagram of an e-mail reply interface of an enterprise instant messaging application client terminal 2 according to an example embodiment.

FIG. 22 and FIG. 23 are schematic diagrams of a unified signature setting interface of an enterprise instant messaging application client terminal 3 according to an example embodiment.

FIG. 24 is a schematic structural diagram of an electronic device according to an example embodiment.

FIG. 25 to FIG. 29 are block diagrams of a signature generating device according to an example embodiment.

FIG. 30 is a schematic structural diagram of another electronic device according to an example embodiment.

FIG. 31 is a block diagram of a signature template sharing device according to an example embodiment.

### DETAILED DESCRIPTION

Example embodiments are described in detail here, and examples thereof are shown in the accompanying drawings. When the accompanying drawings are involved in the following descriptions, the same numeral in different drawings represents the same or similar element, unless otherwise indicated. Implementation manners described in the following example embodiments do not represent all the implementation manners consistent with one or more example embodiments of this disclosure. Instead, they are merely examples of devices and methods consistent with some aspects of one or more example embodiments of this disclosure as described in detail in the appended claims.

In one or more example embodiments of this disclosure, by providing alternative signature templates, an operation of configuring a signature by a user may be simplified, thus improving the efficiency of configuring the signature. In particular, in a group scenario, by providing alternative signature templates, it may be ensured that all members of the same group may use the same signature by using the same signature template, so as to achieve unified management within the group.

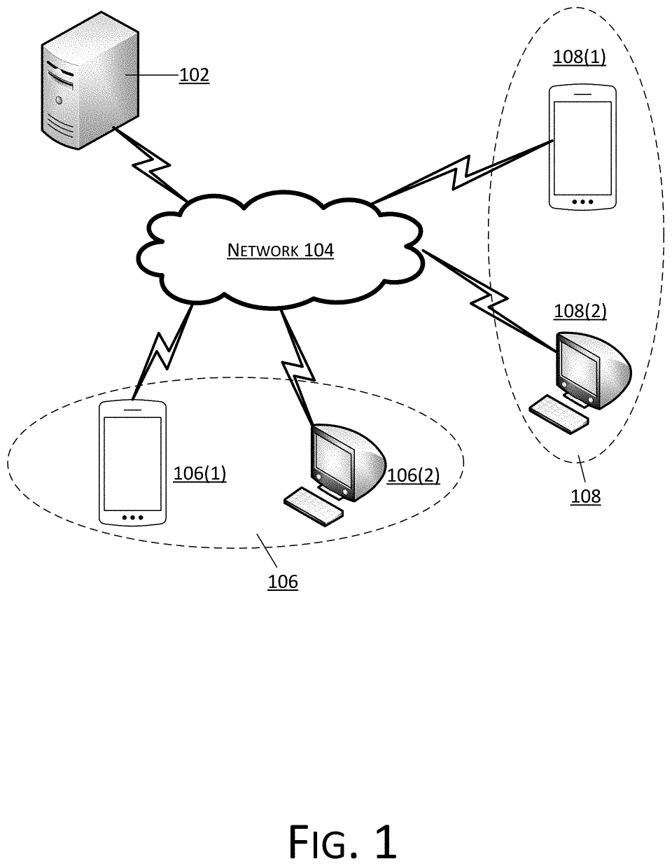

FIG. 1 is a schematic architectural diagram of a communication system according to an example embodiment. As shown in FIG. 1, the system may include a server 102, a network 104, and several electronic devices, such as an electronic device 106 and an electronic device 108.

The server 102 may be a physical server including a separate host, or the server 102 may be a virtual server hosted by a host cluster, or the server 102 may be a cloud server. In the running process, the server 102 may run a program or computer-readable instructions of a certain application at a server side to implement related service functions of the application. For example, when the server 102 runs a program of a mobile group office platform, it may be implemented as a server terminal of the mobile group office platform.

In this example embodiment, the mobile group office platform not only may implement a communication function, but also may serve as an integrated function platform of many other functions, for example, group internal events such as processing on examination and approval events, attendance events, task events, and log events, as well as group external events such as processing on meal ordering and purchasing, which is not limited in one or more example embodiments of this disclosure.

More specifically, the mobile group office platform may be hosted in an instant messaging application in the conventional techniques, for example, in an Enterprise Instant Messaging (EIM) application such as Skype For Business®, Microsoft Teams®, Yammer®, Workplace®, Slack®, WeChat®, Fxiaoke®, Enterprise Fetion®, and Enterprise Easychat®. Certainly, the instant messaging function is only one of the communication functions supported by the mobile group office platform. The group office platform may also implement more other functions like the above, which will not be described in detail here.

The electronic device 106 (such as a mobile phone 106(1) and a PC 106(2)), the electronic device 108 (such as a mobile phone 108(1) and a PC 108(2)) and the like are electronic devices used by different users respectively to meet identities and roles of the different users. For example, a user A may be an administrator of the group, and a user B may be an ordinary member of the group. The electronic device 106, the electronic device 108 and electronic devices used by other users may include various types. For example, the types of the electronic devices may include: mobile phones, Personal Computers (PCs), tablet devices, notebook computers, Personal Digital Assistants (PDAs), wearable devices (such as smart glasses and smart watches), and so on, which is not limited in one or more example embodiments of this disclosure. In the running process, the electronic device may run a program of a certain application at a client terminal side to implement related service functions of the application. For example, when the electronic device runs a program of a mobile group office platform, it may be implemented as a client terminal of the mobile group office platform. It should be noted that an application of a client terminal of the mobile group office platform may be installed in the electronic device 106 and the electronic device 108 in advance, so that the client terminal may be enabled and run on the electronic device 106 and the electronic device 108. Certainly, when an online “client terminal” such as an HTML5 technology is adopted, the client terminal may be obtained and run without the need of installing the corresponding application on the electronic device 106 and the electronic device 108.

The network 104 over which the electronic device 106, the electronic device 108, and the server 102 interact with each other may include various types of wired or wireless networks. In an example embodiment, the network 104 may include a Public Switched Telephone Network (PSTN) and the Internet. At the same time, communication interaction between the electronic device 106 and the electronic device 108 may also be conducted over the network 104. For example, a single chat communication session is established between the electronic device 106 and the electronic device 108; alternatively, several electronic devices may participate in the same group chat communication session so that any user may send a communication message to all other users in the group chat communication session through his/her own electronic device.

The technical solution of the specification is described in detail below with reference to example embodiments.

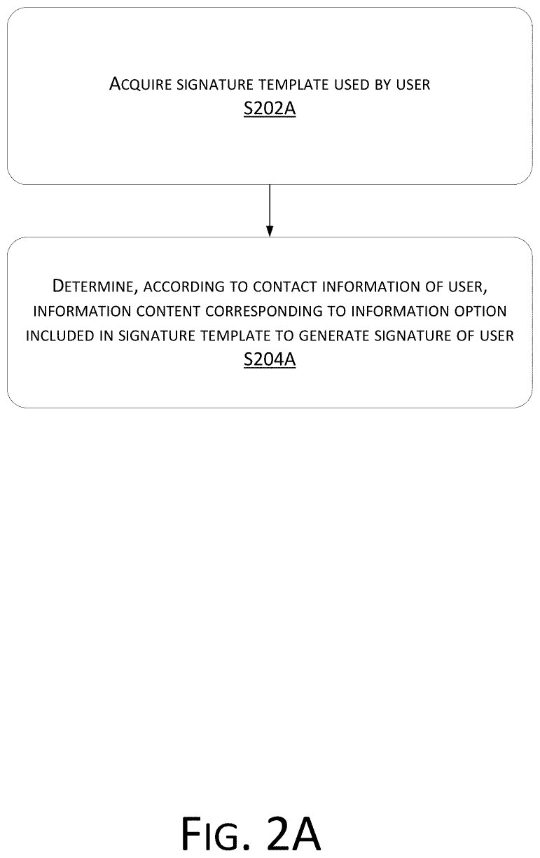

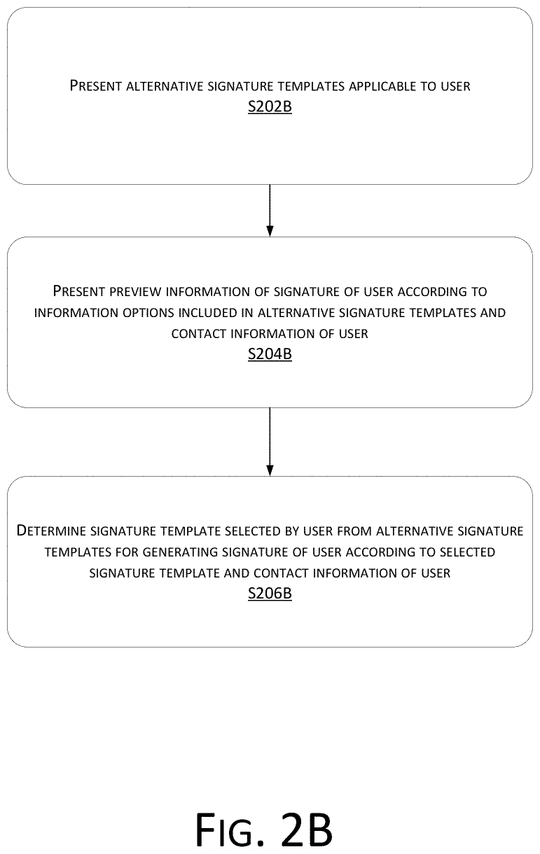

FIG. 2A is a flowchart of a signature generating method according to an example embodiment. As shown in FIG. 2A, the method may include the following steps.

In step 202A, a signature template used by a user is acquired.

In an example embodiment, the communication method in the example embodiment shown in FIG. 2A may be applied to an electronic device, for example, the electronic device 106, the electronic device 108 shown in FIG. 1 and the like, so that the user may acquire a signature template through the corresponding electronic device and generate a corresponding signature.

In an example embodiment, the communication method in the example embodiment shown in FIG. 2A may be applied to a server, for example, the server 102 shown in FIG. 1. The server 102 may determine a signature template that the user wants to use and generate a corresponding signature.

In an example embodiment, the signature template may include a unified signature template for all members in a group to which the user belongs, so that all group members in the same group may configure signatures uniformly, which facilitates the unified management of the signatures of all group members in the same group.

In step 204A, information content corresponding to an information item included in the signature template is determined according to contact information of the user to generate a signature of the user.

In an example embodiment, information content corresponding to the information item may be determined according to contact information of the user to generate a signature of the user. For example, a mobile group office platform supports a configuration function and a contact function of the signature at the same time, and then the mobile group office platform may determine information content of each information item from contact information by comparing the information item included in the signature template with the contact information.

In an example embodiment, the signature template may include at least one of the following information items: a personal information item corresponding to a personal information dimension, such as name, address, and contact number, and a group information item corresponding to a group information dimension, such as group name and group logo.

In an example embodiment, corresponding information content may be determined from the contact information only when the signature is generated, so that the information content may not be changed before the signature is regenerated.

In an example embodiment, when the information content corresponding to the information item in the contact information of the user is changed, the signature of the user may be updated according to the changed contact information, so that information synchronization may be automatically maintained between information content in the signature and the contact information without the need of regenerating the signature by the user, which helps to simplify the operation of the user.

In an example embodiment, an information item in the signature template may be associated with a contact information item in the contact information in advance and a corresponding association relationship is obtained, so that a contact information item in the contact information corresponding to the information item in the signature template may be determined subsequently based on the association relationship, and the signature is automatically updated accordingly. In another example embodiment, the signature may be automatically updated by semantically recognizing the information item in the signature template, the contact information and so on and determining an association relationship between the information item in the signature template and the contact information item in the contact information according to the recognition result. In other example embodiments, the signature may be automatically updated in other manners, which is not limited in this disclosure.

In an example embodiment, when the signature template includes the group information item, the signature of the user includes group information of the group to which the user belongs, and the group information is configured to be linked to an associated presentation interface of the group to which the user belongs, so that a receiving user of the signature may quickly open the associated presentation interface of the group by triggering the group information in the signature, facilitating the receiving user to understand the group.

In an example embodiment, the signature of the user may include: an e-mail signature of the user. In other example embodiments, the signature in this disclosure may also be used for any other function provided by a mobile group office platform. For example, the signature is applied to comment information for audit events or other events, personal signatures for log information, and so on. An application scenario of the signature is not limited in this disclosure.

In an example embodiment, the signature of the user may include: a detail presentation mode applicable to a first scenario and a summary presentation mode applicable to a second scenario. For example, the first scenario may include at least one of the following: a new communication message generation scenario and an inter-group communication scenario; and the second scenario may include at least one of the following: a communication message reply scenario and an intra-group communication scenario.

FIG. 2B is a flowchart of another signature generating method according to an example embodiment. As shown in FIG. 2B, the method may include the following steps.

In step 202B, alternative signature templates applicable to a user are presented.

In an example embodiment, the communication method in the example embodiment shown in FIG. 2B may be applied to an electronic device, for example, the electronic device 106, the electronic device 108 shown in FIG. 1 and the like, so that the user may view and trigger the alternative signature templates through the corresponding electronic device, select a signature template, and generate a corresponding signature.

In an example embodiment, the alternative signature templates may include at least one of the following:

1) a group signature template configured by an administrator of a group to which the user belongs, wherein the group signature template may be provided by the administrator to all group members in the same group, so that all the group members in the same group may configure signatures uniformly, which facilitates the unified management of the signatures of all group members in the same group;

2) a customized template configured by the user, wherein the customized template may be generated completely according to content input by the user or generated by editing another alternative signature template by the user, or generated in another manner, which is not limited in this disclosure; and

3) a shared template from another user or a shared template from another group, wherein the another user and the above user may be from the same group or different groups.

In step 204B, preview information of a signature of the user is presented according to information items included in the alternative signature templates and contact information of the user.

In an example embodiment, the alternative signature templates may include at least one of the following information items: a personal information item corresponding to a personal information dimension, such as name, address, and contact number, and a group information item corresponding to a group information dimension, such as group name and group logo.

In an example embodiment, information content corresponding to the information item may be determined according to contact information of the user to generate a signature of the user. For example, a mobile group office platform supports a configuration function and a contact function of the signature at the same time, and then the mobile group office platform may determine information content of each information item from contact information by comparing the information items included in the alternative signature templates with the contact information.

In an example embodiment, when preview information of the signature is presented to the user, it may help the user understand the corresponding alternative signature templates more intuitively and quickly, so that the user may make a selection, instead of trying out the alternative signature templates one by one.

In step 206B, a signature template selected by the user from the alternative signature templates is determined for generating the signature of the user according to the selected signature template and the contact information of the user.

In an example embodiment, corresponding information content may be determined from the contact information only when the signature is generated, so that the information content may not be changed before the signature is regenerated.

In an example embodiment, when the information content corresponding to the information item in the contact information of the user is changed, the signature of the user may be updated according to the changed contact information, so that information synchronization may be automatically maintained between information content in the signature and the contact information without the need of regenerating the signature by the user, which helps to simplify the operation of the user.

In an example embodiment, an edited signature may be obtained according to an editing operation of the user on the preview information. Then, when the selected signature template corresponds to the preview information, the edited signature may be taken as the signature of the user, so that the signature finally obtained may be compatible with recorded content of the contact information and personalized content that the user wants to add.

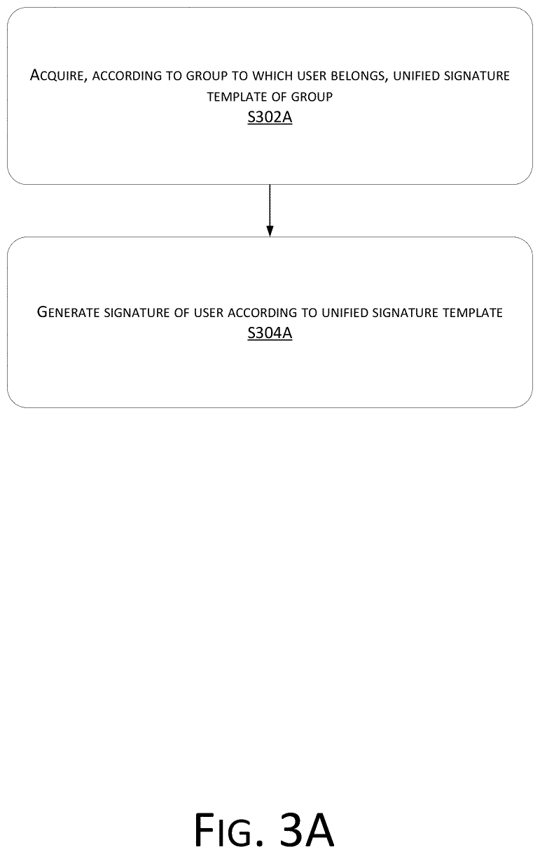

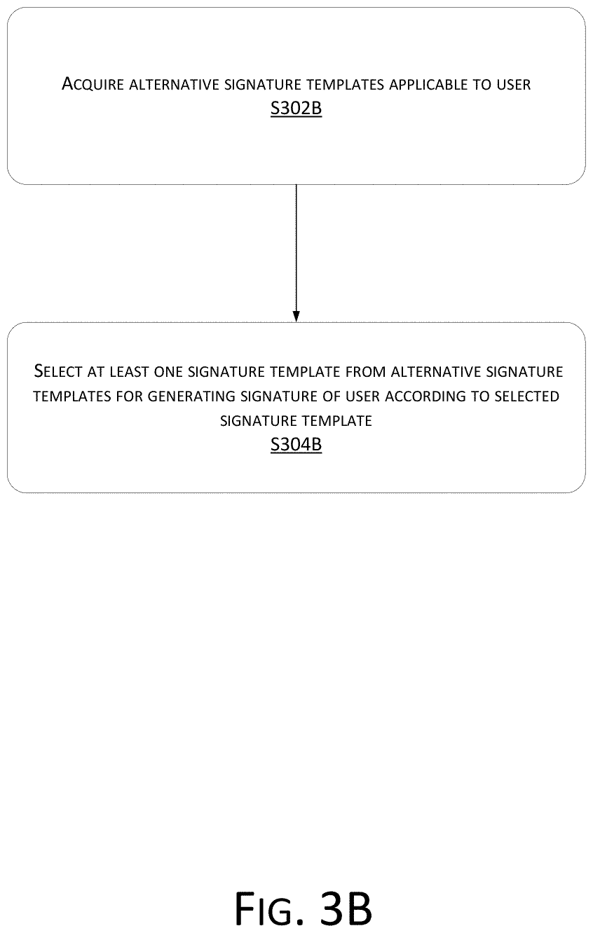

FIG. 3A is a flowchart of still another signature generating method according to an example embodiment. As shown in FIG. 3A, the method may include the following steps.

In step 302A, a unified signature template of the group is acquired according to a group to which a user belongs.

In an example embodiment, the communication method in the example embodiment shown in FIG. 3A may be applied to an electronic device, for example, the electronic device 106, the electronic device 108 shown in FIG. 1 and the like, so that the user may acquire a unified signature template of a group, to which the user belongs, through the corresponding electronic device and generate a corresponding signature.

In an example embodiment, the communication method in the example embodiment shown in FIG. 3A may be applied to a server, for example, the server 102 shown in FIG. 1. The server 102 may provide the user with a unified signature template of a group to which the user belongs and generate a corresponding signature.

In an example embodiment, a unified signature template is used by all members in a group to which the user belongs, so that all group members in the same group may configure signatures uniformly, which facilitates the unified management of the signatures of all group members in the same group.

In step 304A, a signature of the user is generated according to the unified signature template.

In an example embodiment, the unified signature template may be configured by an administrator of the group. The administrator may include, for example, an administrator or creator of the group or another group member having a management permission.

In an example embodiment, information content corresponding to an information item included in the unified signature template may be determined according to contact information of the user to generate the signature of the user. For example, a mobile group office platform supports a configuration function and a contact function of the signature at the same time, and then the mobile group office platform may determine information content of each information item from contact information by comparing the information item included in the unified signature template with the contact information.

In an example embodiment, the unified signature template may include at least one of the following information items: a personal information item corresponding to a personal information dimension, such as name, address, and contact number, and a group information item corresponding to a group information dimension, such as group name and group logo.

In an example embodiment, corresponding information content may be determined from the contact information only when the signature is generated, so that the information content may not be changed before the signature is regenerated.

In an example embodiment, when the information content corresponding to the information item in the contact information of the user is changed, the signature of the user may be updated according to the changed contact information, so that information synchronization may be automatically maintained between information content in the signature and the contact information without the need of regenerating the signature by the user, which helps to simplify the operation of the user.

In an example embodiment, an information item in the unified signature template may be associated with a contact information item in the contact information in advance and a corresponding association relationship is obtained, so that a contact information item in the contact information corresponding to the information item in the unified signature template may be determined subsequently based on the association relationship, and the signature is automatically updated accordingly. In another example embodiment, the signature may be automatically updated by semantically recognizing the information item in the unified signature template, the contact information and so on and determining an association relationship between the information item in the unified signature template and the contact information item in the contact information according to the recognition result. In other example embodiments, the signature may be automatically updated in other manners, which is not limited in this disclosure.

In an example embodiment, when the unified signature template includes the group information item, the signature of the user includes group information of the group to which the user belongs, and the group information is configured to be linked to an associated presentation interface of the group to which the user belongs, so that a receiving user of the signature may quickly open the associated presentation interface of the group by triggering the group information in the signature, facilitating the receiving user to understand the group.

In an example embodiment, the signature of the user may include: an e-mail signature of the user. In other example embodiments, the signature in this disclosure may also be used for any other function provided by a mobile group office platform. For example, the signature is applied to comment information for audit events or other events, personal signatures for log information, and so on. An application scenario of the signature is not limited in this disclosure.

In an example embodiment, the signature of the user may include: a detail presentation mode applicable to a first scenario and a summary presentation mode applicable to a second scenario. For example, the first scenario may include at least one of the following: a new communication message generation scenario and an inter-group communication scenario; and the second scenario may include at least one of the following: a communication message reply scenario and an intra-group communication scenario.

FIG. 3B is a flowchart of still another signature generating method according to an example embodiment. As shown in FIG. 3B, the method may include the following steps.

In step 302B, alternative signature templates applicable to a user are acquired.

In an example embodiment, the communication method in the example embodiment shown in FIG. 3B may be applied to an electronic device, for example, the electronic device 106, the electronic device 108 shown in FIG. 1 and the like, so that the user may acquire alternative signature templates through the corresponding electronic device, select a signature template, and generate a corresponding signature.

In an example embodiment, the communication method in the example embodiment shown in FIG. 3B may be applied to a server, for example, the server 102 shown in FIG. 1. The server 102 may provide the user with alternative signature templates applicable to the user and generate a corresponding signature according to a signature template selected by the user.

In an example embodiment, the alternative signature templates may include at least one of the following:

1) a group signature template configured by an administrator of a group to which the user belongs, wherein the group signature template may be provided by the administrator to all group members in the same group, so that all the group members in the same group may configure signatures uniformly, which facilitates the unified management of the signatures of all group members in the same group;

2) a customized template configured by the user, wherein the customized template may be generated completely according to content input by the user or generated by editing another alternative signature template by the user, or generated in another manner, which is not limited in this disclosure; and

3) a shared template from another user or a shared template from another group, wherein the another user and the above user may be from the same group or different groups.

In an example embodiment, the user may choose a signature generated according to the alternative signature template or choose a customized signature, thus realizing the compatibility and cooperation with the conventional techniques.

In an example embodiment, the alternative signature templates may include a unified template for all members in a group to which the user belongs, so that all group members in the same group may configure signatures uniformly, which facilitates the unified management of the signatures of all group members in the same group.

In step 304B, at least one signature template is selected from the alternative signature templates for generating a signature of the user according to the selected signature template.

In an example embodiment, the alternative signature templates may include at least one of the following information items: a personal information item corresponding to a personal information dimension, such as name, address, and contact number, and a group information item corresponding to a group information dimension, such as group name and group logo.

In an example embodiment, information content corresponding to the information item may be determined according to contact information of the user to generate a signature of the user. For example, a mobile group office platform supports a configuration function and a contact function of the signature at the same time, and then the mobile group office platform may determine information content of each information item from contact information by comparing the information items included in the alternative signature templates with the contact information.

In an example embodiment, corresponding information content may be determined from the contact information only when the signature is generated, so that the information content may not be changed before the signature is regenerated.

In an example embodiment, when the information content corresponding to the information item in the contact information of the user is changed, the signature of the user may be updated according to the changed contact information, so that information synchronization may be automatically maintained between information content in the signature and the contact information without the need of regenerating the signature by the user, which helps to simplify the operation of the user.

In an example embodiment, an information item in the alternative signature templates may be associated with a contact information item in the contact information in advance and a corresponding association relationship is obtained, so that a contact information item in the contact information corresponding to the information item in the alternative signature templates may be determined subsequently based on the association relationship, and the signature is automatically updated accordingly. In another example embodiment, the signature may be automatically updated by semantically recognizing the information item in the alternative signature templates, the contact information and so on and determining an association relationship between the information item in the alternative signature templates and the contact information item in the contact information according to the recognition result. In other example embodiments, the signature may be automatically updated in other manners, which is not limited in this disclosure.

In an example embodiment, when the alternative signature templates include the group information item, the signature of the user includes group information of the group to which the user belongs, and the group information is configured to be linked to an associated presentation interface of the group to which the user belongs, so that a receiving user of the signature may quickly open the associated presentation interface of the group by triggering the group information in the signature, facilitating the receiving user to understand the group.

In an example embodiment, the signature of the user may include: an e-mail signature of the user. In other example embodiments, the signature in this disclosure may also be used for any other function provided by a mobile group office platform. For example, the signature is applied to comment information for audit events or other events, personal signatures for log information, and so on. An application scenario of the signature is not limited in this disclosure.

In an example embodiment, the signature of the user may include: a detail presentation mode applicable to a first scenario and a summary presentation mode applicable to a second scenario. For example, the first scenario may include at least one of the following: a new communication message generation scenario and an inter-group communication scenario; and the second scenario may include at least one of the following: a communication message reply scenario and an intra-group communication scenario.

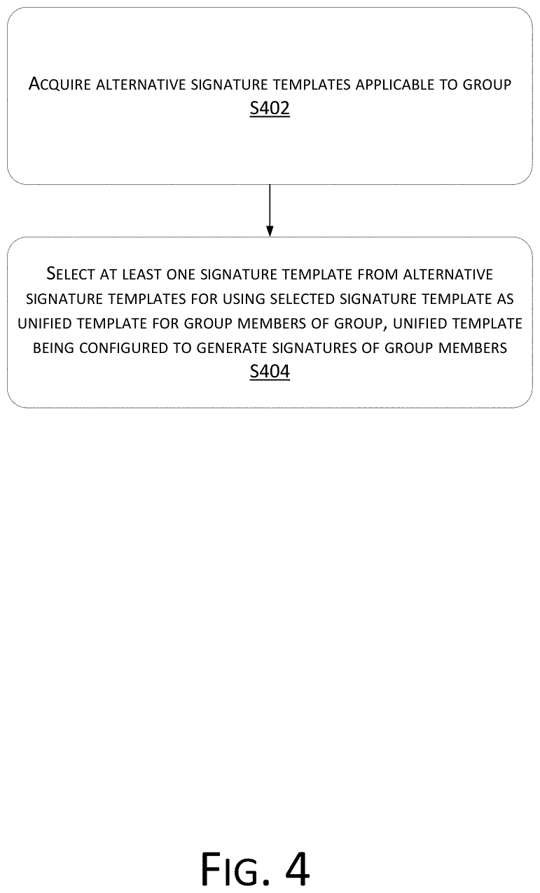

FIG. 4 is a flowchart of still another signature generating method according to an example embodiment. As shown in FIG. 4, the method may include the following steps.

In step 402, alternative signature templates applicable to a group are acquired.

In an example embodiment, the communication method in the example embodiment shown in FIG. 4 may be applied to an electronic device, for example, the electronic device 106, the electronic device 108 shown in FIG. 1 and the like.

In an example embodiment, the communication method in the example embodiment shown in FIG. 4 may be applied to an electronic device used by an administrator in a group, so that the administrator may select a signature template uniformly for all group members in the group, which facilitates the unified management of the signatures of all group members in the same group.

In an example embodiment, the alternative signature templates may include at least one of the following:

1) a customized template configured by the user, wherein the customized template may be generated completely according to content input by the user or generated by editing another alternative signature template by the user, or generated in another manner, which is not limited in this disclosure; and

2) a shared template from another user or a shared template from another group, wherein the another user and the above user may be from the same group or different groups.

In step 404, at least one signature template is selected from the alternative signature templates for using the selected signature template as a unified template for group members of the group, the unified template being configured to generate signatures of the group members.

In an example embodiment, the alternative signature templates may include at least one of the following information items: a personal information item corresponding to a personal information dimension, such as name, address, and contact number, and a group information item corresponding to a group information dimension, such as group name and group logo.

In an example embodiment, information content corresponding to the information item may be determined according to contact information of the group members to generate a signature of the user. For example, a mobile group office platform not only supports a configuration function of the signature, but also may support organizational structure information of the group and a contact function of each group member, and then the mobile group office platform may determine information content of each information item from contact information by comparing the information items included in the alternative signature templates with the contact information.

In an example embodiment, corresponding information content may be determined from the contact information only when the signature is generated, so that the information content may not be changed before the signature is regenerated.

In an example embodiment, when the information content corresponding to the information item in the contact information of the group members is changed, the signature of the group members may be updated according to the changed contact information, so that information synchronization may be automatically maintained between information content in the signature and the contact information without the need of regenerating the signature by the group members, which helps to simplify the operations of the group members.

In an example embodiment, when the alternative signature templates include the group information item, the signature of the group member includes group information of the group, and the group information is configured to be linked to an associated presentation interface of the group, so that a receiving user of the signature may quickly open the associated presentation interface of the group by triggering the group information in the signature, facilitating the receiving user to understand the group.

In an example embodiment, the signature of the group member may include: an e-mail signature of the user. In other example embodiments, the signature in this disclosure may also be used for any other function provided by a mobile group office platform. For example, the signature is applied to comment information for audit events or other events, personal signatures for log information, and so on. An application scenario of the signature is not limited in this disclosure.

In an example embodiment, the signature of the group member may include: a detail presentation mode applicable to a first scenario and a summary presentation mode applicable to a second scenario. For example, the first scenario may include at least one of the following: a new communication message generation scenario and an inter-group communication scenario; and the second scenario may include at least one of the following: a communication message reply scenario and an intra-group communication scenario.

In the technical solution of this disclosure, the adopted signature template may be shared among groups. The sharing process of the signature template is described below.

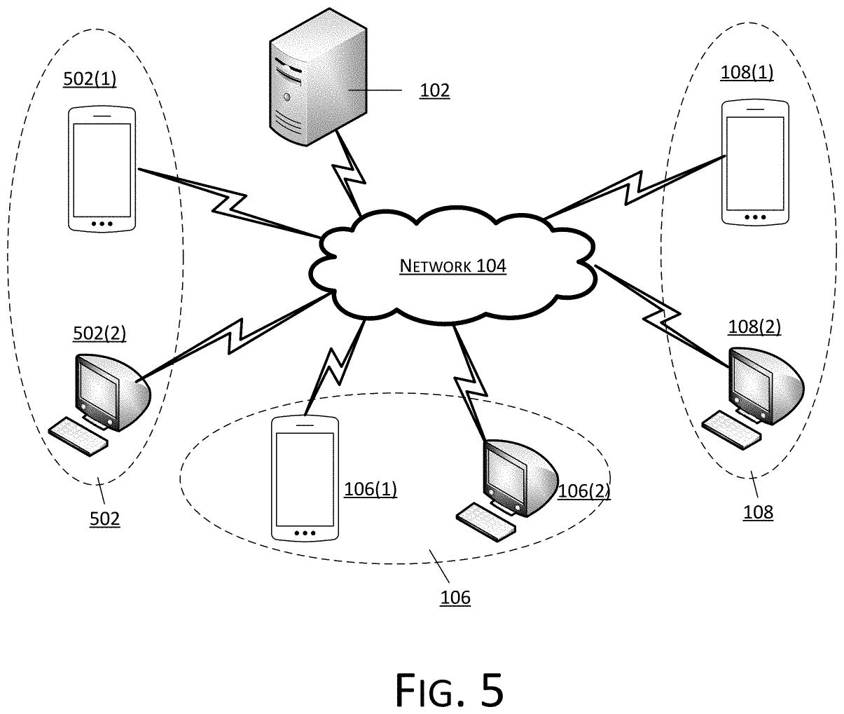

FIG. 5 is a schematic architectural diagram of a signature template sharing system according to an example embodiment of this application. As shown in FIG. 5, in addition to the server 102, the network 104, the electronic device 106, and the electronic device 108 shown in FIG. 1, the system may also include another electronic device 502 such as a mobile phone 502(1) and a PC 502(2).

Like the electronic device 106 and the electronic device 108, the electronic device 502 may include the following types: mobile phones, PCs, tablet devices, notebook computers, handheld computers, wearable devices (such as smart glasses and smart watches), and so on, which is not limited in this application. In the running process, the electronic device 106, the electronic device 108, and the electronic device 502 may run a program of a certain application at a client terminal side to implement related service functions of the application. For example, they each may be implemented as a client terminal of the mobile group office platform.

Then, when the electronic device 106 and the electronic device 108 correspond to a first group and the electronic device 502 corresponds to a second group, a signature template of the first group may be shared to the second group or a signature template of the second group is shared to the first group. The sharing process is described in detail below with reference to example embodiments.

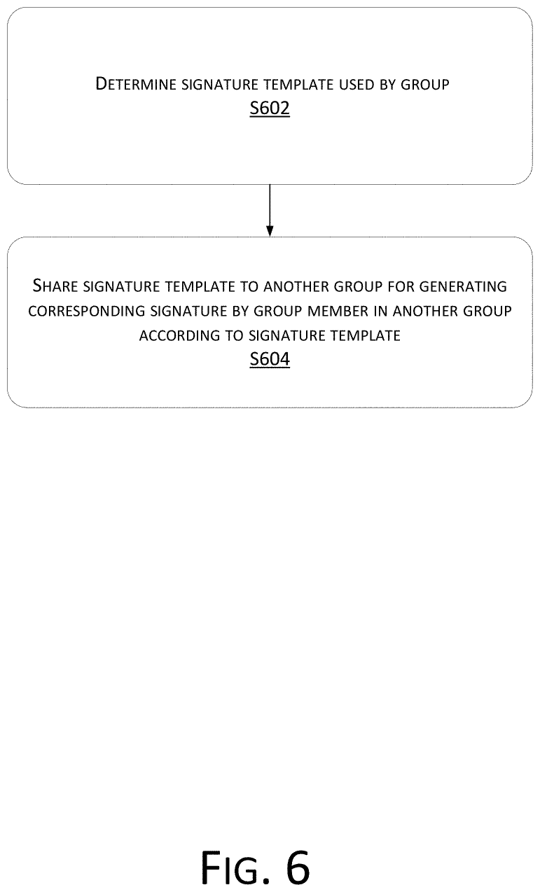

FIG. 6 is a flowchart of a signature template sharing method according to an example embodiment. As shown in FIG. 6, the method may include the following steps.

In step 602, a signature template used by a group is determined.

In step 604, the signature template is shared to another group for generating a corresponding signature by a group member in the another group according to the signature template.

In this example embodiment, the signature template may be sent to the another group; or the signature template may be shared to a sharing platform to be pushed from the sharing platform to the another group; or the signature template may be shared to the sharing platform, wherein the another group has a permission to access the sharing platform. Certainly, the signature template may also be shared in other manners, which is not limited in this disclosure.

In this example embodiment, when the signature template is updated, updated data may be sent to the another group for updating the signature template used by the another group, thus further updating a signature of group members in the another group.

For ease of understanding, the technical solution of one or more example embodiments of this disclosure is described by taking an enterprise instant messaging application “enterprise instant messaging application” as an example. Assuming that an enterprise instant messaging application client terminal is run on the electronic device 106, the electronic device 108, and the electronic device 502, and an enterprise instant messaging application server terminal is run on the server 102. Registered accounts of different users are logged in to the enterprise instant messaging application client terminals on the electronic device 106, the electronic device 108, and the electronic device 502 respectively. For example, a registered account of a user A is logged in to the electronic device 106, so that the electronic device 106 is configured as an enterprise instant messaging application client terminal 1 corresponding to the user A, a registered account of a user B is logged in to the electronic device 108, so that the electronic device 108 is configured as an enterprise instant messaging application client terminal 2 corresponding to the user B, and a registered account of a user C is logged in to the electronic device 502, so that the electronic device 502 is configured as an enterprise instant messaging application client terminal 3 corresponding to the user C.

Assuming that the user A and the user B both belong to an enterprise AA and the user C belongs to an enterprise BB, wherein the user A is an administrator of the enterprise AA, the user B is an ordinary member of the enterprise AA, and the user C is an administrator of the enterprise BB.

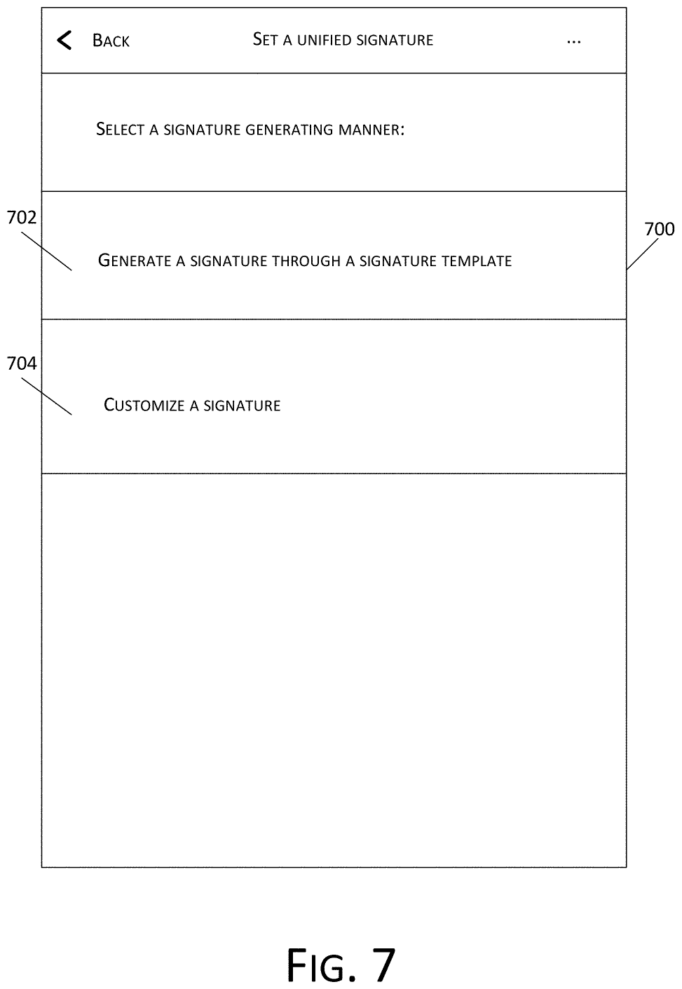

FIG. 7 is a schematic diagram of a unified signature setting interface of an enterprise instant messaging application client terminal 1 according to an example embodiment. As shown in FIG. 7, the user A may configure a unified signature for all members of the enterprise AA through a unified signature setting interface 700. Certainly, if the user A is also an administrator of another group, a unified signature may also be configured for all members of the groups through the unified signature setting interface 700.

In an example embodiment, the unified signature setting interface 700 may include a first option 702 and a second option 704. The first option 702 is used to realize “generating a signature through a signature template,” and the second option 704 is used to realize “customize a signature.” In order to facilitate the determination of user intention, the above two different forms may be distinguished in the manner as shown in FIG. 7 for the user A to choose.

When the user A triggers the second option 704, a unified signature may be created, but the signature cannot be used as a template to implement self-adaption to different members. For example, when the signature created by the user A is “from the enterprise AA,” if the signature is applied to all members of the enterprise AA, the signature used by each member of the enterprise AA is “from the enterprise AA,” that is, the signatures of all the members have exactly the same content. In practice, in many cases, since the signature should include personal information of each member, such as name and phone number, the requirement may not be met based on the above “customize a signature,” which needs to be implemented based on the first option 702 and its corresponding functions.

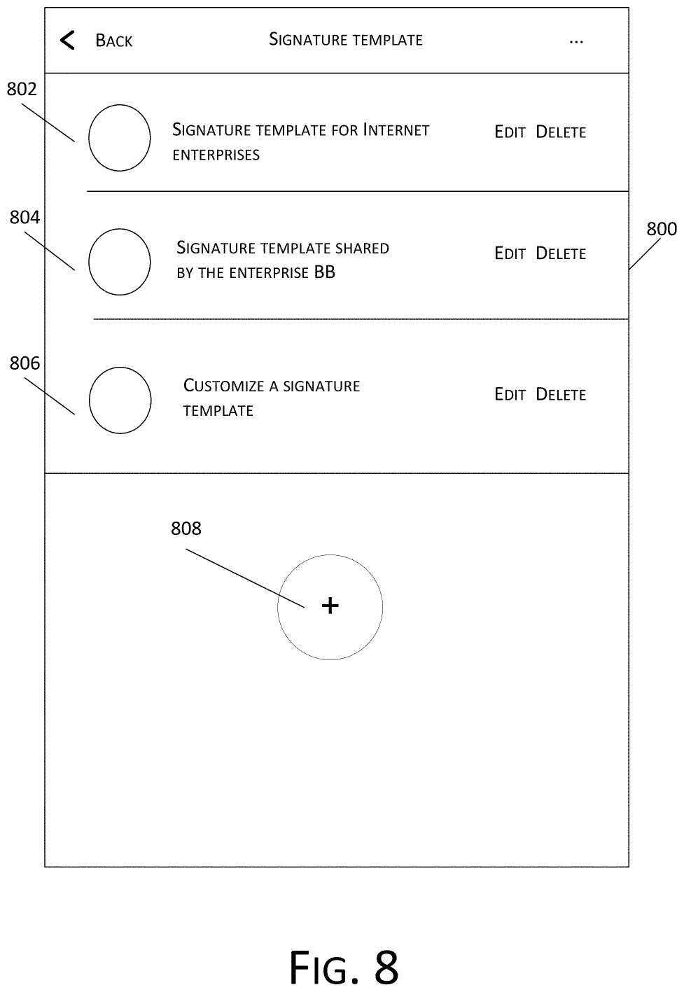

FIG. 8 is a schematic diagram of a signature template setting interface of an enterprise instant messaging application client terminal 1 according to an example embodiment. When the user A triggers the first option 702, a signature template setting interface 800 shown in FIG. 8 may be redirected to. A signature template that has already existed may be shown on the signature template setting interface 800, which may include, for example, a first template 802, a second template 804, and a third template 806 shown in FIG. 8. At the same time, the user A may further create a signature template by triggering an adding identifier 808.

There may be a plurality of sources for the signature template.

In one case, for example, a “signature template for Internet enterprises” corresponding to the first template 802 shown in FIG. 8 may be created and added by developers of enterprise instant messaging application and then provided to users of the enterprise instant messaging application, such as the user A. The enterprise instant messaging application may provide the first template 802 or the like to the user A in a plurality of manners. For example, the user A may view and acquire the first template 802 by browsing a template sharing platform provided by the enterprise instant messaging application. For another example, the first template 802 may be configured as a signature template included on the signature template setting interface 800 by default, so that the user A may obtain the first template 802 through the signature template setting interface 800 without any operation.

In another case, for example, a “signature template shared by the enterprise BB” corresponding to the second template 804 shown in FIG. 8 may be created by a user C or another user of the enterprise BB and then shared to another group such as the enterprise AA, so that the user A may acquire and apply the second template 804. The sharing of the second template 804 by the user C will be described in detail hereinafter and is not repeated here.

In another case, for example, “customize a signature template” corresponding to the third template 806 shown in FIG. 8 may be created by the user A actively on the enterprise instant messaging application client terminal 1 in a manner such as triggering an adding identifier 808, so that the user A may determine content included in the corresponding signature more independently.

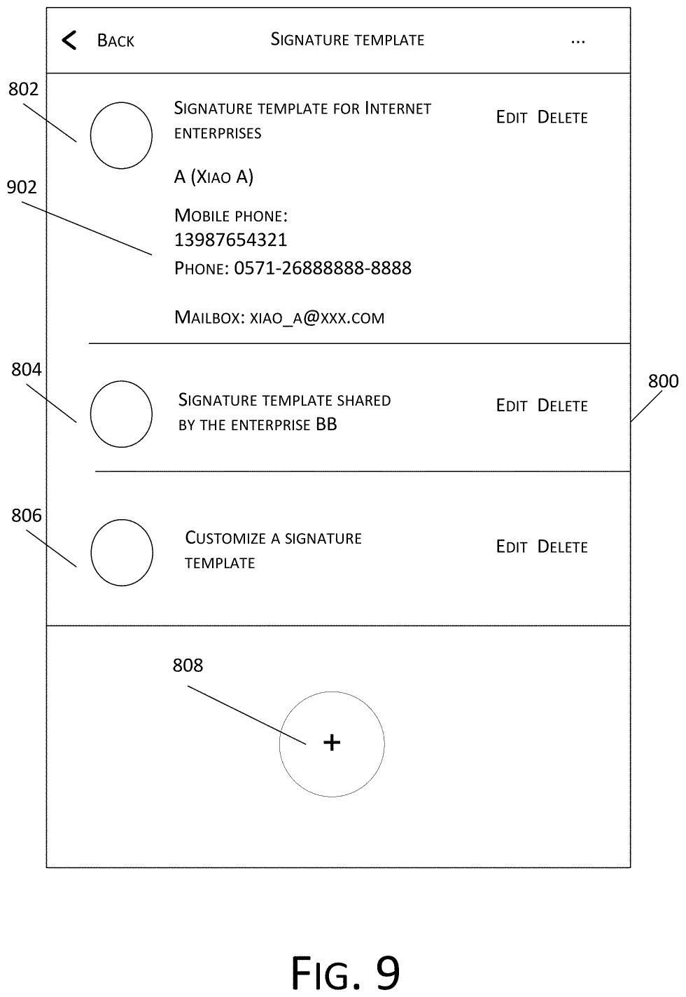

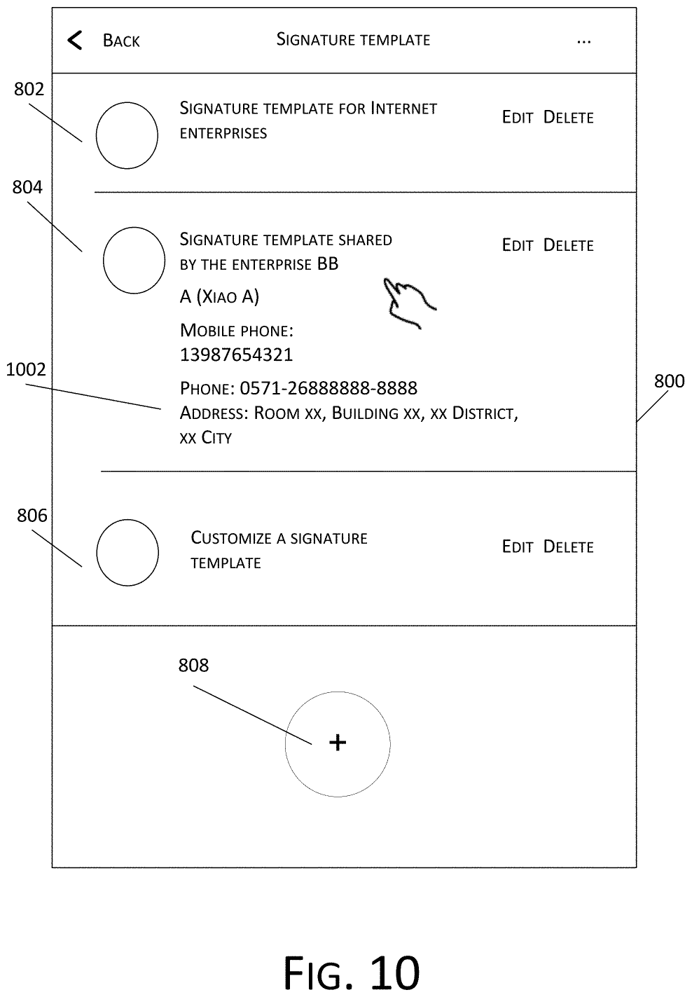

FIG. 9 and FIG. 10 are schematic diagrams of a preview signature of an enterprise instant messaging application client terminal 1 according to an example embodiment. As shown in FIG. 9 and FIG. 10, the user A may view preview information of the corresponding signature by triggering the signature template presented on the signature template setting interface 800. For example, as shown in FIG. 9, when it is detected that a user triggers the first template 802, signature preview information 1002 obtained based on the first template 802 may be presented on the enterprise instant messaging application client terminal 1. For example, as shown in FIG. 10, when it is detected that a user triggers the second template 804, signature preview information 8041 obtained based on the second template 804 may be presented on the enterprise instant messaging application client terminal 1. As may be seen, by triggering each signature template and browsing the corresponding signature preview information, the user A may more easily understand each signature template without trying and changing them one by one, which helps to simplify the operation of the user.

By taking FIG. 9 as an example, the enterprise instant messaging application may generate the corresponding signature preview information 8011 according to the first template 802 and the contact information of the user A. The generation process may be completed on the enterprise instant messaging application client terminal 1 and may also be completed on an enterprise instant messaging application server terminal. Several personal information items such as name (nickname), mobile phone, phone, and mailbox may be included in the first template 802, and the enterprise instant messaging application may determine information content of these personal information items according to contact information of the user A. For example, the name (nickname) is “A (Xiao A),” the mobile phone is “13987654321,” the phone is “0571-26888888-8888,” the mailbox is xiao_a@xxx.com, and so on. Similarly, personal information items such as name (nickname), mobile phone, phone and address may be included in the second template 804 shown in FIG. 10, and corresponding information content may also be determined based on the contact information of the user A, which is not described in detail here. In other example embodiments, in addition to the above personal information items, the signature template may also include other types of information items, for example, a group information item corresponding to group information, such as the name of a group and an address where the group is located. Like the personal information items, information content of the group information items may also be determined according to the contact information of the user A or the like, which is not described in detail here.

Still by taking FIG. 9 as an example, in the process of generating the signature preview information 8011, the enterprise instant messaging application needs to match the personal information items (the processing procedure of other information items are similar) included in the first template 802 with the contact information of the user A for determining information content corresponding to the personal information items.

In an example embodiment, when the first template 802 is generated, an association relationship may be established between each personal information item in the first template 802 with a contact information item in the contact information, for example, “mobile phone” in the first template 802 with “mobile phone number” in the contact information, “mailbox” in the first template 802 with “e-mail” in the contact information, and so on. Therefore, the enterprise instant messaging application may determine a contact information item in the contact information corresponding to each personal information item in the first template 802 according to the association relationship, and accordingly determine information content corresponding to each personal information item, thus the corresponding signature generating preview information 8011.

In another example embodiment, the enterprise instant messaging application may semantically recognize the personal information items in the first template 802 and contact information items in the contact information and accordingly automatically obtain an association relationship between each personal information item in the first template 802 with a contact information item in the contact information respectively, thus generating the corresponding signature preview information 8011 according to the association relationship.

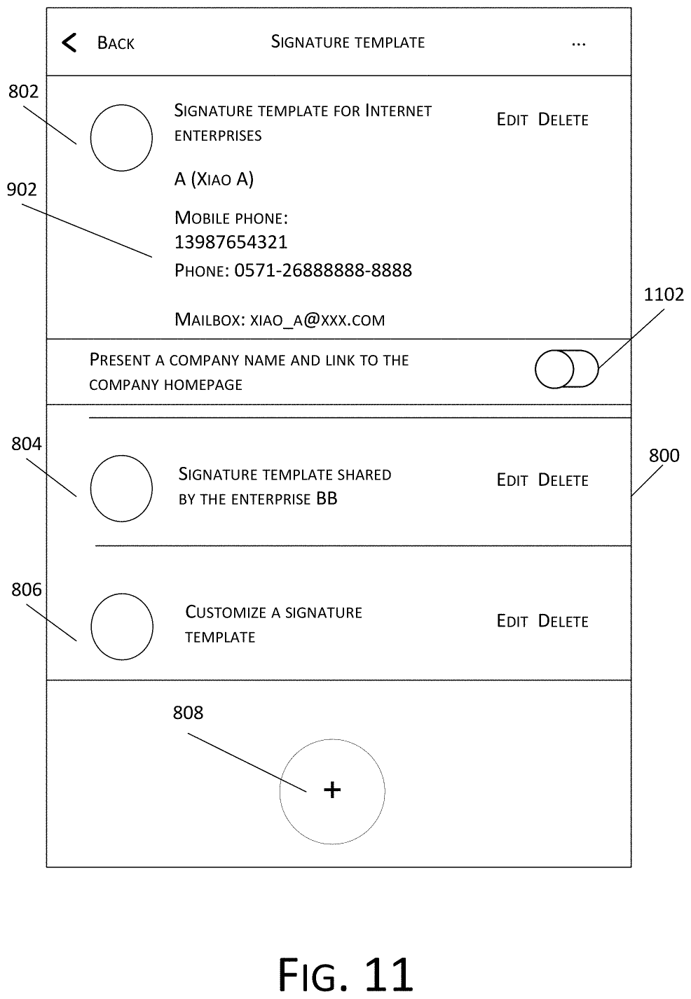

FIG. 11 is a schematic diagram of addition of group information of an enterprise instant messaging application client terminal 1 according to an example embodiment. As shown in FIG. 11, the enterprise instant messaging application client terminal 1 may provide an option 1102 to enable the user A to determine, by controlling the option 1102, whether a group information item needs to be included in the first template 802. For example, in the example embodiment shown in FIG. 11, a group information item “company name” may be included in the first template 802 by triggering the option 1102, and the company name displayed in the signature may also implement a function of “link to the company homepage.” When the user A belongs to the enterprise AA, the “company homepage” may be an associated presentation interface of the enterprise AA. For example, the associated presentation interface may be an enterprise function interface of the enterprise AA on the enterprise instant messaging application, which is configured to present description information of the enterprise AA and trigger a service function related to the enterprise AA, and so on. For another example, the associated presentation interface may be any other function interfaces related to the enterprise AA, which is not limited in this disclosure.

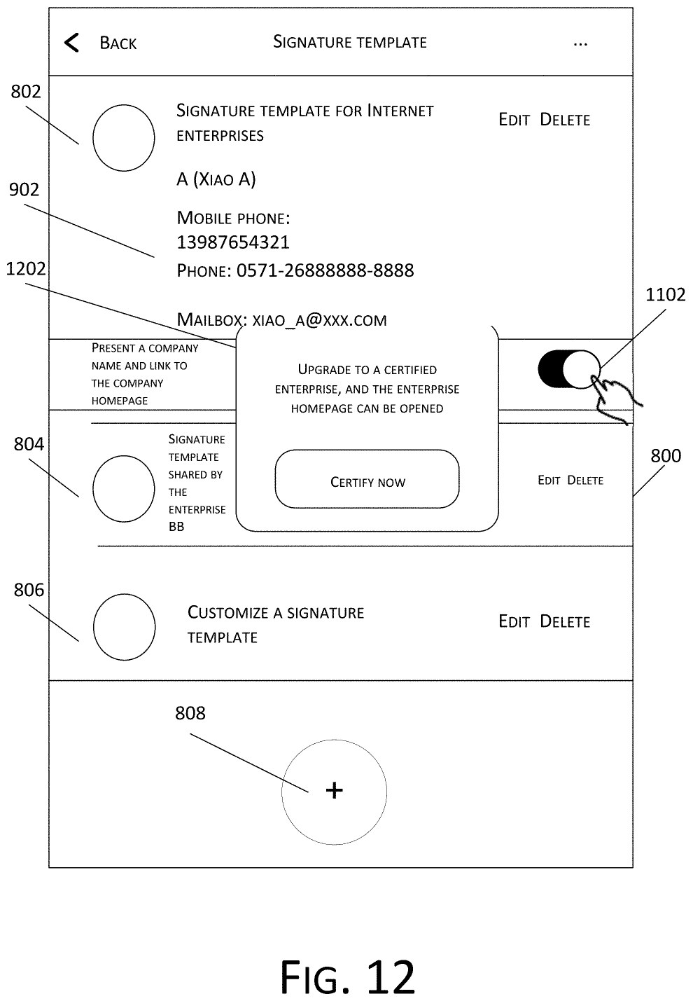

FIG. 12 is a schematic diagram of an enterprise certification prompt window of an enterprise instant messaging application client terminal 1 according to an example embodiment. When detecting that the user A triggers an ON option 1102, the enterprise instant messaging application may determine whether the enterprise AA to which the user A belongs meets a preset condition and provide a prompt and an operation guide to the user A when the preset condition is not met. For example, assuming that the preset condition is that the enterprise AA is a “certified enterprise” defined by the enterprise instant messaging application, in a case for example where business license and legal person information of the enterprise AA need to be submitted to the enterprise instant messaging application to determine the authenticity and validity of the enterprise AA, when the enterprise AA has not yet passed the certification, an enterprise certification prompt window 1202 shown in FIG. 12 may be shown to guide the user A to start a certification operation on the enterprise AA by triggering a “certify now” option. In other example embodiments, assuming that the user AA does not have a certification permission, information such as “please contact the administrator for certification” may be presented in the enterprise certification prompt window 1202 to guide the user A to contact the administrator for performing the certification operation on the enterprise AA.

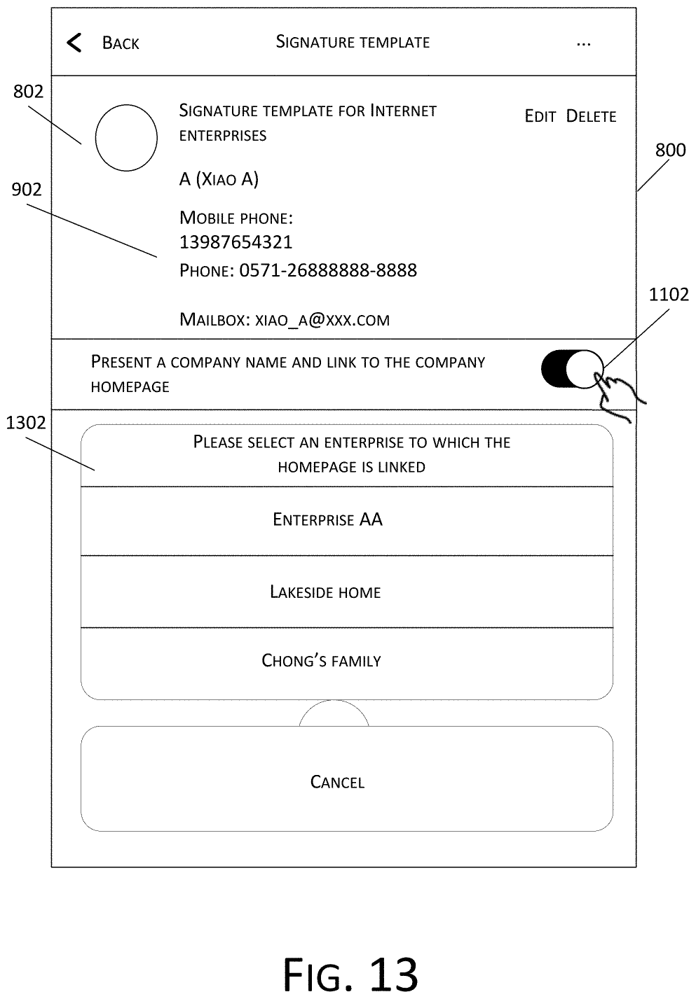

FIG. 13 is a schematic diagram of selection of a linked enterprise of an enterprise instant messaging application client terminal 1 according to an example embodiment. As shown in FIG. 13, when the user A belongs to a plurality of enterprises at the same time or when the user A is an administrator of a plurality of enterprises at the same time, an enterprise selection window 1302 shown in FIG. 13 may be presented on the signature template setting interface 800. All enterprises which the user A belongs to or has a management permission for, such as “enterprise AA,” “lakeside home,” and “Chong's family,” shown in FIG. 13 may be presented in the enterprise selection window 1302, for the user A to choose.

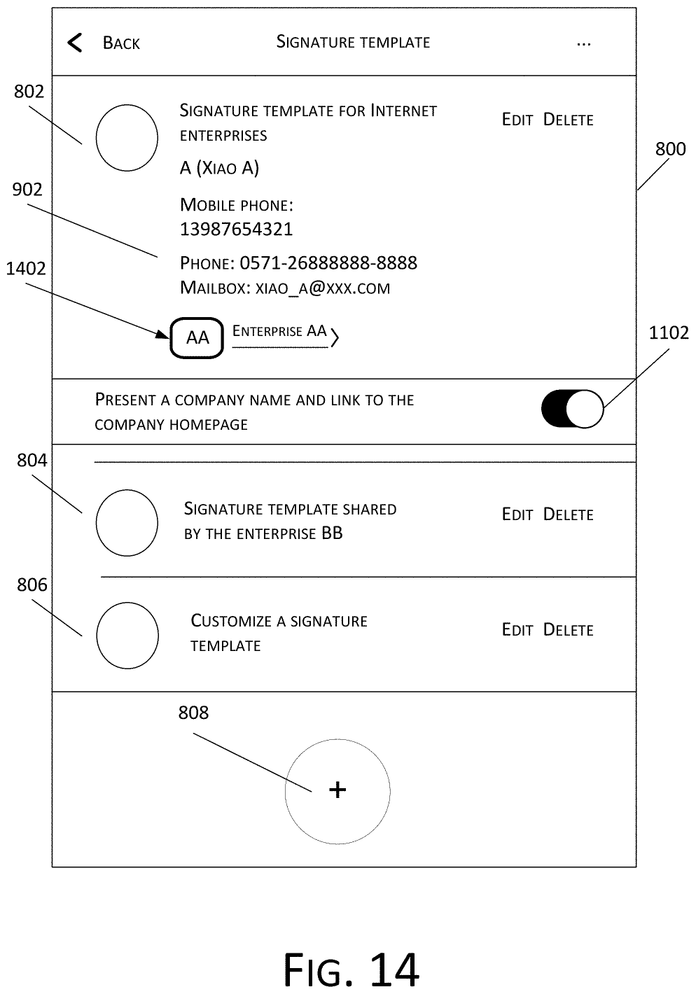

FIG. 14 is another schematic diagram of a preview signature of an enterprise instant messaging application client terminal 1 according to an example embodiment. As shown in FIG. 14, when the user A belongs only to the enterprise AA or has a specific management permission only for the enterprise AA, or the user A selects the “enterprise AA” through the enterprise selection window 1302 shown in FIG. 13, the signature preview information 902 corresponding to the first template 802 may include enterprise information 1402 shown in FIG. 14 based on an operation of triggering the option 1102 by the user A. In this case, it may be considered that the first template 802 includes a personal information item and a group information item at the same time, wherein the personal information item includes the above name (nickname), mobile phone, phone, mailbox and so on, and the group information item includes group logo and group name. For example, a rounded rectangle identified as “AA” in the enterprise information 1402 may be information content of the group logo, and “enterprise AA” may be information content of the group name. At the same time, in the signature preview information 902 shown in FIG. 14, as described above, group information 1402 may also be linked to the company homepage of the enterprise AA, which is not described in detail here.

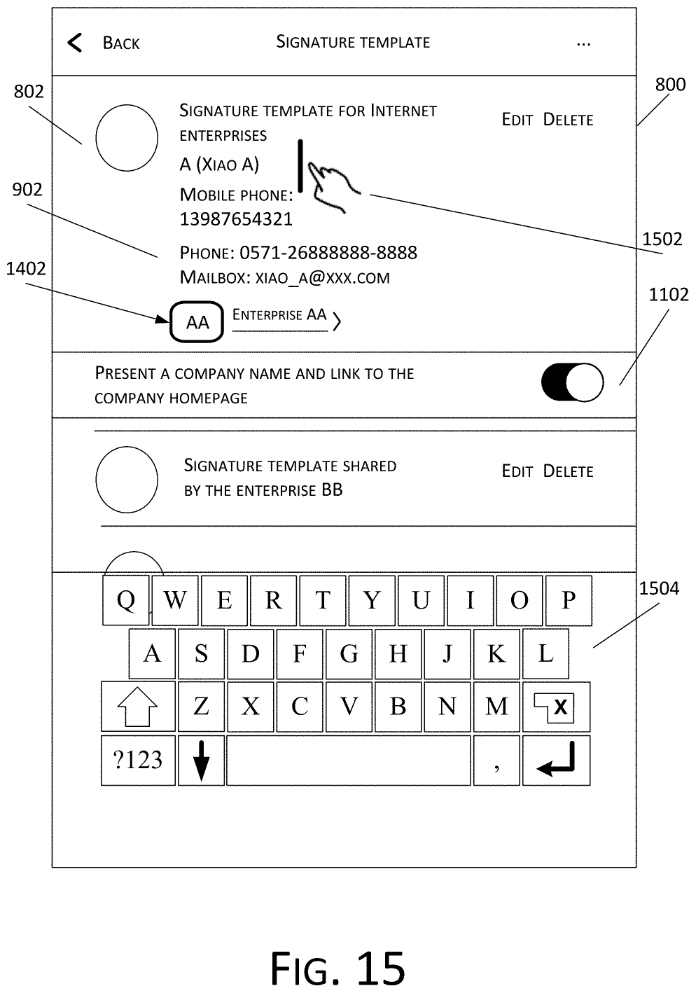

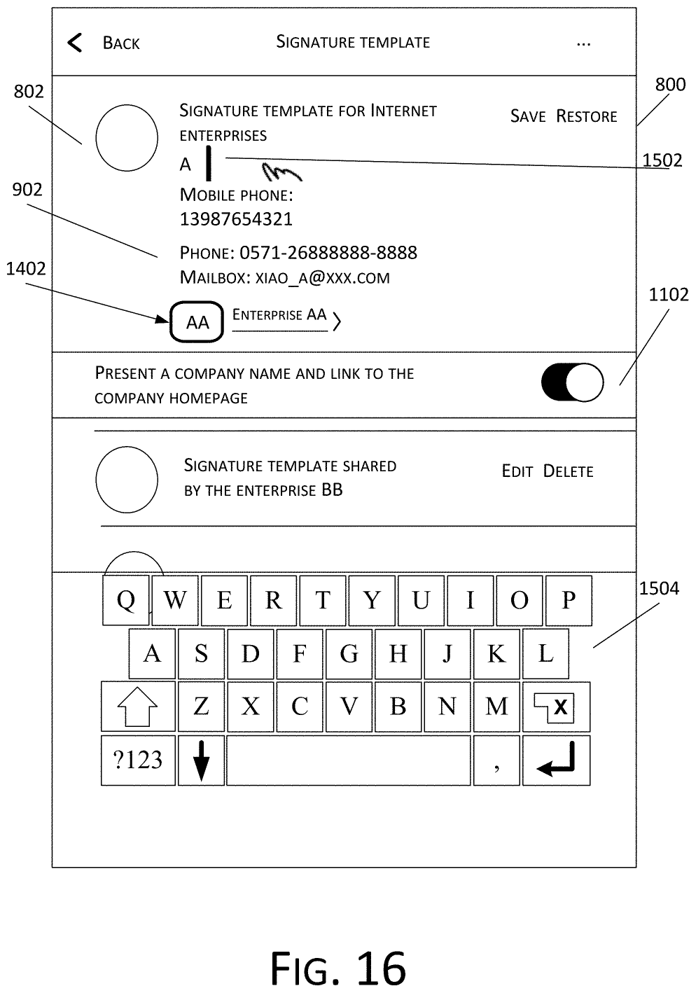

FIG. 15 and FIG. 16 are schematic diagrams of editing of a signature template of an enterprise instant messaging application client terminal 1 according to an example embodiment. The user A may edit a signature template, especially a signature template provided by enterprise instant messaging application or shared by another enterprise to make it more in line with the requirements of the enterprise AA. As shown in FIG. 15, by taking the first template 802 as an example, the user A may click the signature preview information 902, the enterprise instant messaging application client terminal 1 may show a control cursor 1502 at the click position and show a keyboard 1504 on the signature template setting interface 800 for the user A to edit the signature preview information 902 through the keyboard 1504. Assuming that the user A deletes “(Xiao A)” in the signature preview information 902 shown in FIG. 15 and obtains the edited signature preview information 902 shown in FIG. 16, the enterprise instant messaging application may determine that an actual editing requirement of the user A is: modifying the personal information item “name (nickname)” in the first template 802 as “name.” In other example embodiments, the signature template may also be edited in other manners, which are not described in detail one by one here.

When the user A has edited the signature preview information 902, functional options on the right side of the “signature template for Internet enterprises” may be changed from “edit” and “delete” as shown in FIG. 15 into “save” and “restore” as shown in FIG. 16, and the user A may keep the editing operation performed on the “signature template for Internet enterprises” by triggering the “save” functional option or restore the “signature template for Internet enterprises” to its unedited state by triggering the “restore” functional option.

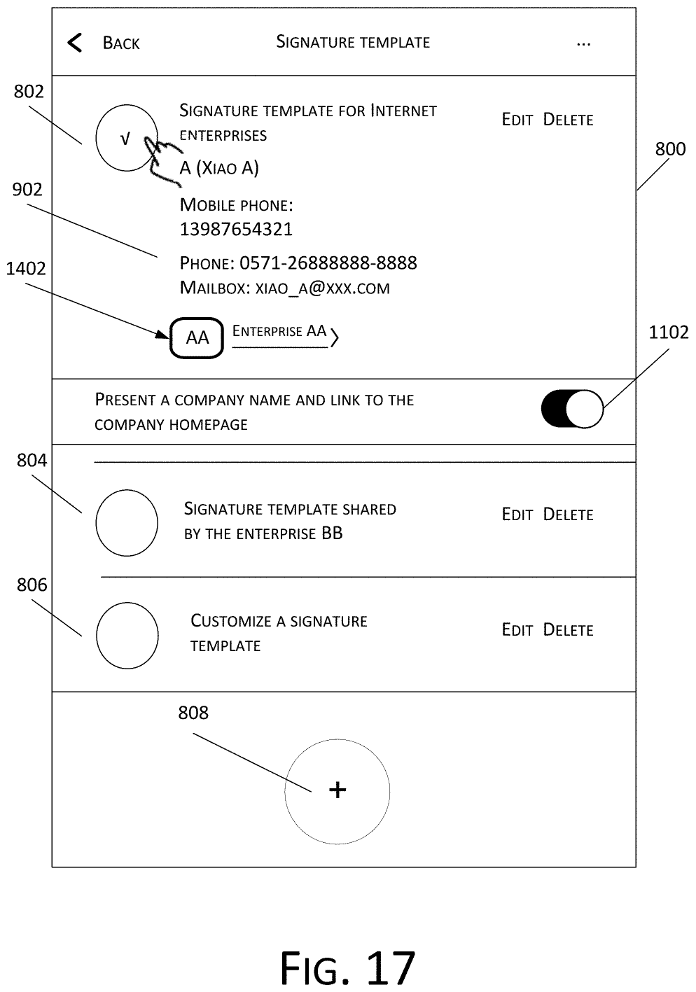

FIG. 17 is a schematic diagram of setting of a unified group signature of an enterprise instant messaging application client terminal 1 according to an example embodiment. As shown in FIG. 17, a corresponding “o” option is included in each of the first template 802, the second template 804, the third template 806 and so on presented on the signature template setting interface 800. When it is detected that the user A triggers the “o” option corresponding to the first template 802 or the like, it indicates that the first template 802 is selected by the user A, so that the first template 802 may be applied to all members of the enterprise AA or the first template 802 is pushed to all members of the enterprise AA for the members to choose and apply.

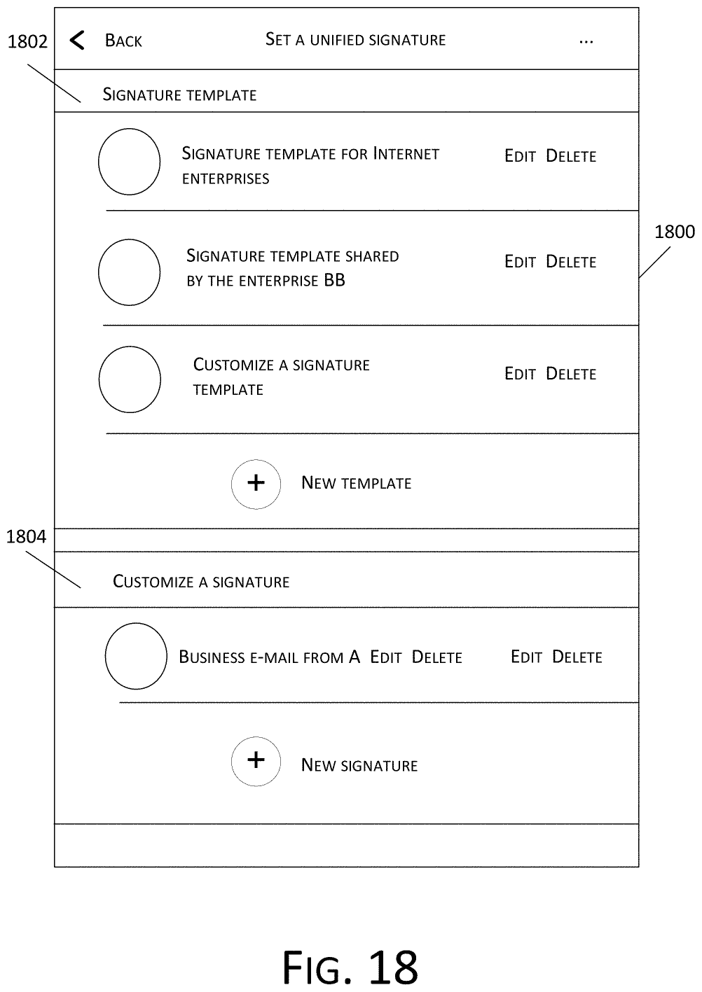

FIG. 18 is another schematic diagram of a unified signature setting interface of an enterprise instant messaging application client terminal 1 according to an example embodiment. In addition to that the user A is guided to the signature template setting interface 800 or customizes the signature through the first option 702 and the second option 704 in the unified signature setting interface 700 shown in FIG. 7, related content of the “signature template” and the “customize a signature” may also be presented on a unified signature setting interface 1800 through the unified signature setting interface 1800 shown in FIG. 18. For example, all signature templates may be presented in a template presentation area 1802, and all customized signatures are presented in a signature presentation area 1804. Customization of the signature, customization of the signature template, preview of the signature template, editing of the signature template, selection of the signature template, and so on may all be obtained with reference to the example embodiments shown in the above FIG. 7 to FIG. 17, which are not described in detail here.

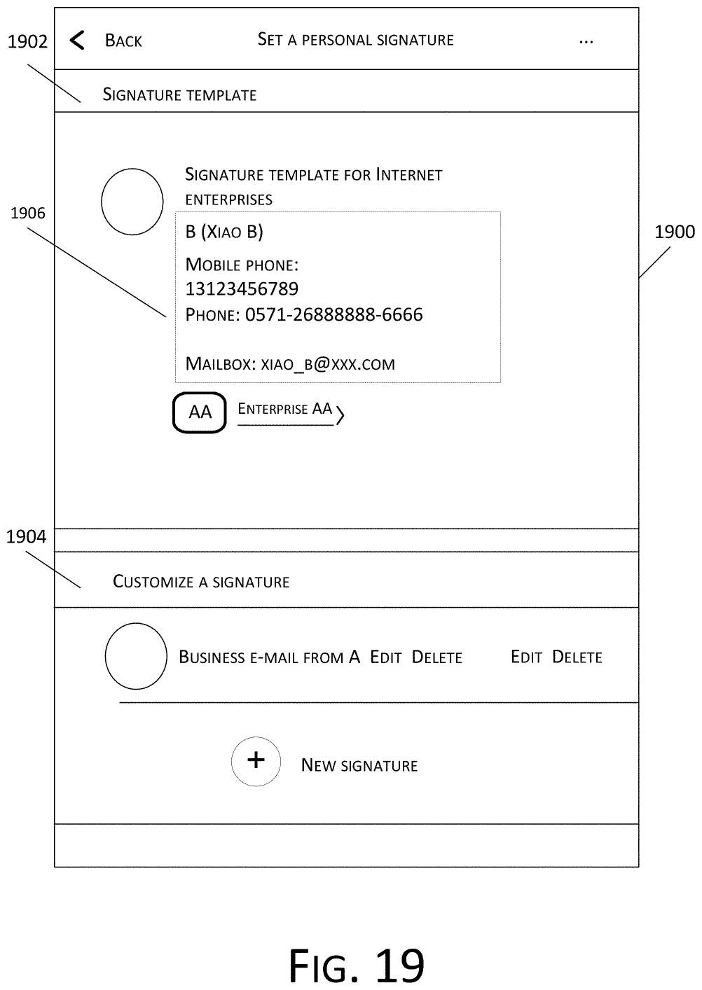

FIG. 19 is a schematic diagram of a personal signature setting interface of an enterprise instant messaging application client terminal 2 according to an example embodiment. As shown in FIG. 19, by taking an ordinary member user B of the enterprise AA as an example, the user B may set his/her own signature through a personal signature setting interface 1900. A template presentation area 1902 for presenting a signature template and a signature presentation area 1904 for presenting a signature are included in the personal signature setting interface 1900. The “signature template for Internet enterprises” configured for all members of the enterprise AA by the user A may be presented in the template presentation area 1902. The signature template is from the above first template 802 as shown in FIG. 17.

In an example embodiment, different from the user A who is an administrator, the user B does not have a permission to create, edit, and delete the signature template, but may only passively accept the signature template configured by the user A. In other example embodiments, the user B may also have the permission to create, edit, and delete the signature template, which helps to enhance the freedom of choice of the user B.

As shown in FIG. 19, the enterprise instant messaging application client terminal 2 may show corresponding signature preview information 1906 in the template presentation area 1902 according to the “signature template for Internet enterprises” and contact information of the user B for the user B to view. In particular, when a plurality of signature templates is included in the template presentation area 1902, it is easy for the user B to quickly determine a signature template that he/she wants to use by viewing signature preview information corresponding to each signature template. Similarly, when the “signature template for Internet enterprises” is applied to other members of the enterprise AA, it may be self-adapted to contact information of these members to generate a signature or signature preview information corresponding to each member.

In addition to the signature template, the user B may edit or delete the customized signature in the signature presentation area 1904, or create a customized signature based on a “new signature” identifier as shown in FIG. 19. In an example embodiment, a customized signature created by the user B may only be applied to himself/herself but cannot be applied to other users. In other example embodiments, the user B may share the customized signature.

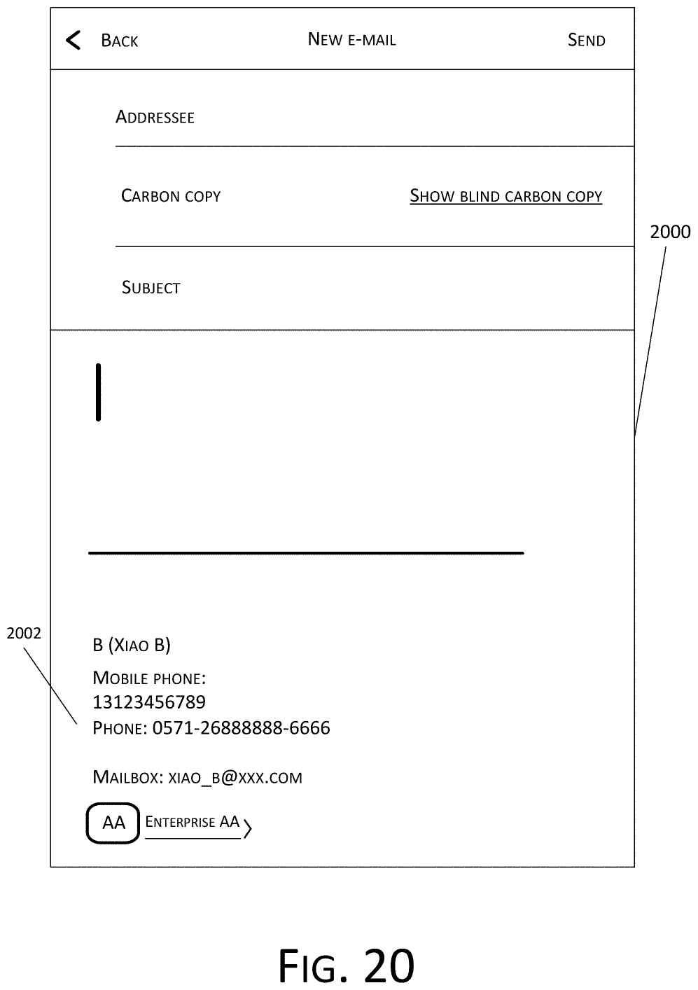

FIG. 20 is a schematic diagram of a new e-mail interface of an enterprise instant messaging application client terminal 2 according to an example embodiment. As shown in FIG. 20, assuming that the user B chooses to use the “signature template for Internet enterprises” shown in FIG. 19, and a corresponding signature 2002 may be automatically generated at the end of the body of an e-mail on a new e-mail interface 2000. The signature 2002 is automatically generated by the enterprise instant messaging application according to the “signature template for Internet enterprises” and the contact information of the user B without manual input of the user B.

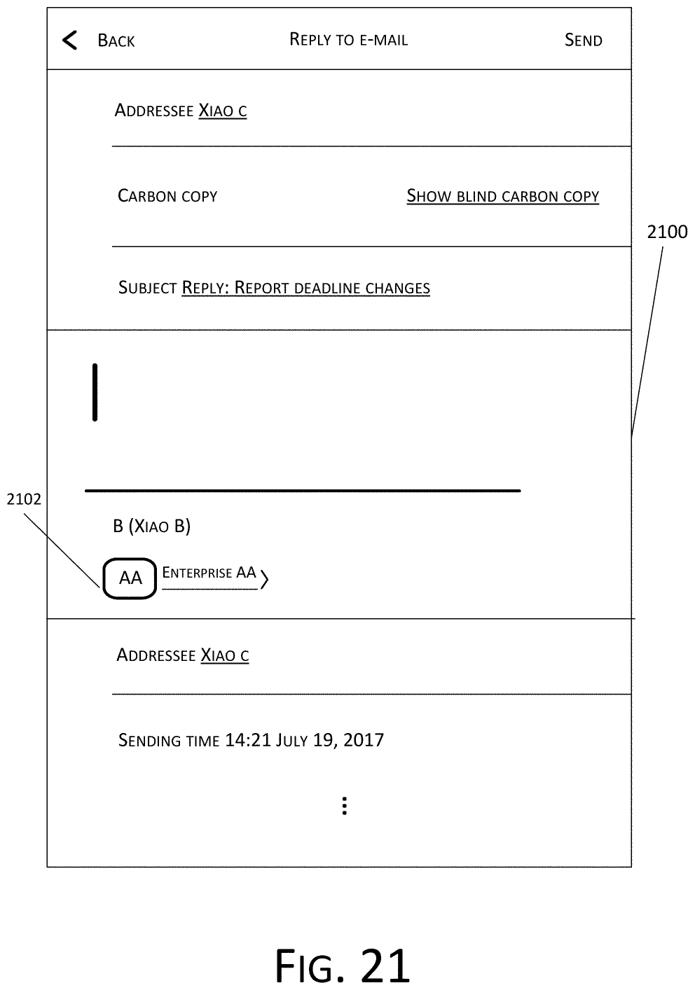

FIG. 21 is a schematic diagram of an e-mail reply interface of an enterprise instant messaging application client terminal 2 according to an example embodiment. As shown in FIG. 21, assuming that the user B chooses to use the “signature template for Internet enterprises” shown in FIG. 19, and a corresponding signature 2102 may also be automatically generated at the end of the body of reply content on an e-mail reply interface 2100. In the example embodiments shown in FIG. 20 and FIG. 21, when the enterprise instant messaging application client terminal 2 detects that it is in a new e-mail scenario shown in FIG. 20, a detail-mode signature 2002 may be used, that is, content included in the signature 2002 may be the same as the signature preview information 1906 shown in FIG. 19. When the enterprise instant messaging application client terminal 2 detects that it is in an e-mail reply scenario shown in FIG. 21, a summary-mode signature 2102 may be used, that is, the signature 2102 may only include some content of the signature preview information 1906, and which content is specifically used may be determined and selected according to actual situations, which is not limited in this disclosure. For example, the name (nickname), the group logo, the group name and so on shown in FIG. 21 may be used.

In the new e-mail scenario, as the addressee may not be familiar with or even have no contact with the user B, the use of the detail-mode signature 2002 may help the addressee get familiar with the user B and the enterprise AA and may also make the e-mail appear more formal. In the e-mail reply scenario, the addressee has contacted the user B at least once, and thus it is less likely to be familiar with the user B and the enterprise AA through a signature, more display areas may be used to display other e-mail content by using the summary-mode signature 2102, and it is easier for both users to focus on viewing these email content, which is conducive to improving the communication efficiency.

In addition to the new e-mail scenario and the e-mail reply scenario, the detail-mode or summary-mode signature may also be chosen for use in other scenarios. For example, when in an inter-group communication scenario, that is, communication parties participating in the communication are from different groups, for example, in the process that the user B of the enterprise AA communicates with the user C of the enterprise BB, the enterprise instant messaging application client terminal 2 may use a detail-mode signature to help the user C understand the user B and the enterprise AA through the signature. When in an intra-group communication scenario, that is, communication parties participating in the communication are from the same group, for example, in the process that the user B of the enterprise AA communicates with the user A, the enterprise instant messaging application client terminal 2 may use a summary-mode signature because members of the same group are often familiar with each other or know each other well.

In addition to the e-mail sending and receiving scenario, the signature in this disclosure may also be applied to any other scenarios, such as comment scenarios for audit events or other events and personal signature scenarios for log information, which is not limited in this disclosure.

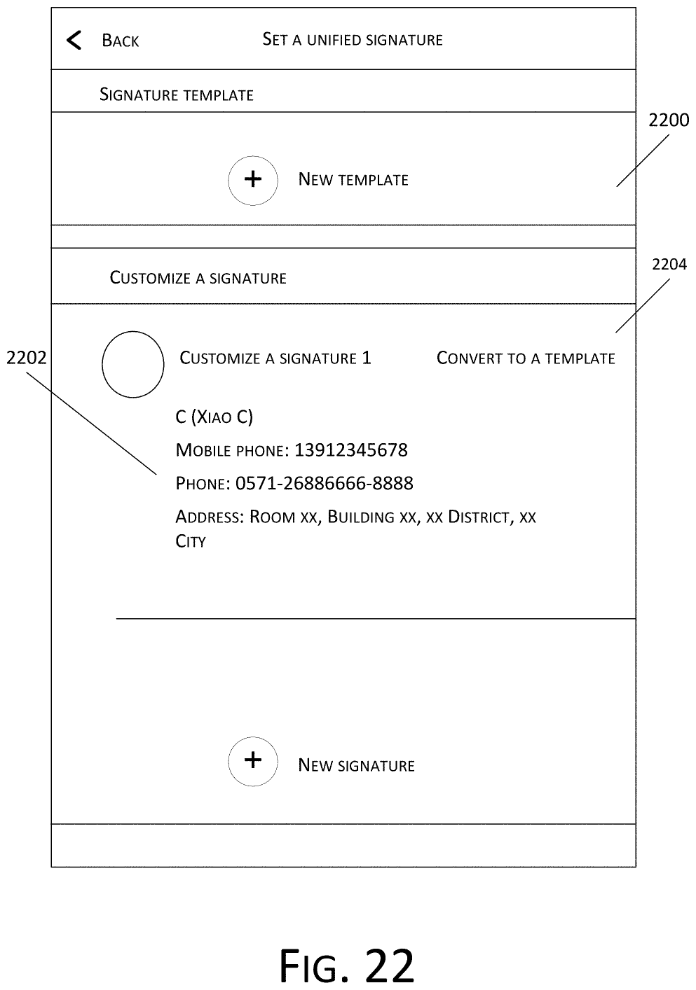

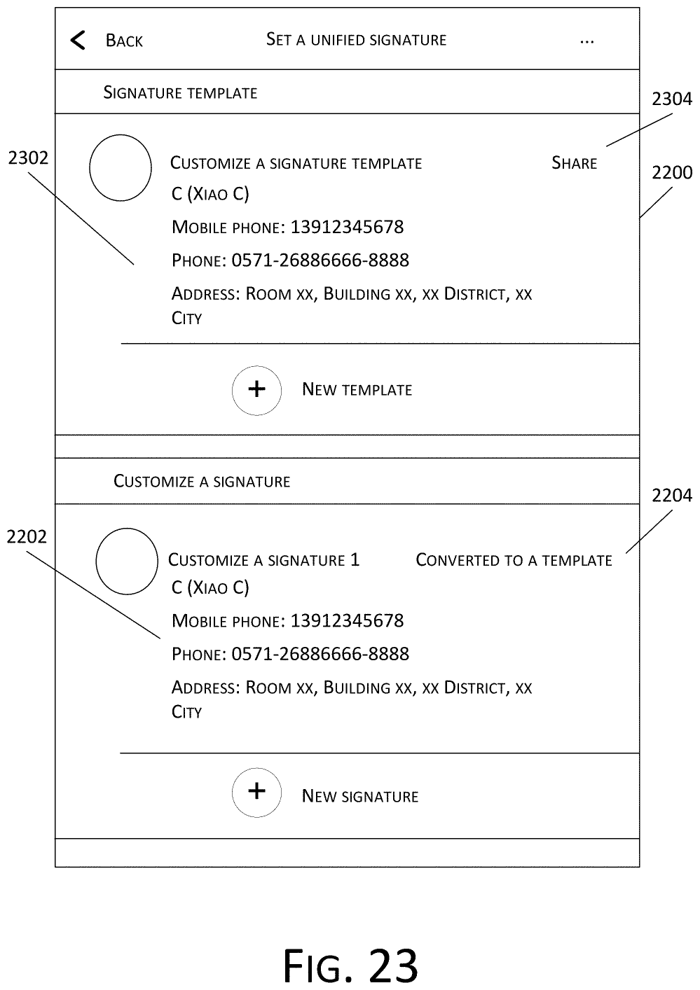

The solution of sharing a signature in this disclosure is described below with reference to FIG. 22 and FIG. 23 by taking the process of sharing a signature template by the user C as an example. FIGS. 22 and 23 are schematic diagrams are a unified signature setting interface of an enterprise instant messaging application client terminal 3 according to an example embodiment.

It is assumed that the unified signature setting interface 2200 shown in FIG. 22 and FIG. 23 adopts the above form in the example embodiment shown in FIG. 18. As shown in FIG. 22, the user C may create a “customize a signature 1” or other customized signatures by triggering a “new signature” identifier, and signature preview information 2202 of the “customize a signature 1” may be presented on the unified signature setting interface 2200 for the user C to view. A functional option 2204 for the “customize a signature 1” may be presented on the unified signature setting interface 2200. The functional option 2204 is used to implement a function of “convert to a template,” that is, the “customize a signature 1” is converted to a signature template.

According to an operation of triggering the functional option 2204 by the user C, the enterprise instant messaging application may convert the “customize a signature 1” to a corresponding signature template. For example, the signature template may be presented as a “customize a signature template” shown in FIG. 23, and corresponding signature preview information 2302 is presented. In other example embodiments, the user C may generate a customized signature template by triggering a “new template” identifier in the unified signature setting interface 2200, and it is unnecessary to first generate a customized signature and then convert the customized signature to a signature template.

As shown in FIG. 23, a sharing option 2304 corresponding to the “customize a signature template” may be presented on the unified signature setting interface 2200. When an operation of triggering the sharing option 2304 by the user C is detected, the “customize a signature template” may be shared to another user or another group through the enterprise instant messaging application client terminal 3. In some example embodiments, in addition to the signature template customized by the user C, signature templates obtained in other ways may also be shared. For example, the user C may obtain a signature template shared by a user D and share the signature template to the user A.

For example, the user C may share the signature template so that the user A may view and obtain the “signature template shared by the enterprise BB” shown in FIG. 8.

In an example embodiment, the user C may directly share the “signature template shared by the enterprise BB” to the user A, or the user C may share the “signature template shared by the enterprise BB” to the enterprise AA, so that the user A may obtain the signature template as an administrator of the enterprise AA.

In another example embodiment, the user C may share the “signature template shared by the enterprise BB” to the enterprise instant messaging application, and the enterprise instant messaging application further shares it to the user A.

In still another example embodiment, the user C may share the “signature template shared by the enterprise BB” to a sharing platform maintained by the enterprise instant messaging application. The sharing platform may be used to receive signature templates shared by all users of the enterprise instant messaging application. Then, when the user A has a permission to access the sharing platform, the user A may view and obtain the “signature template shared by the enterprise BB.”

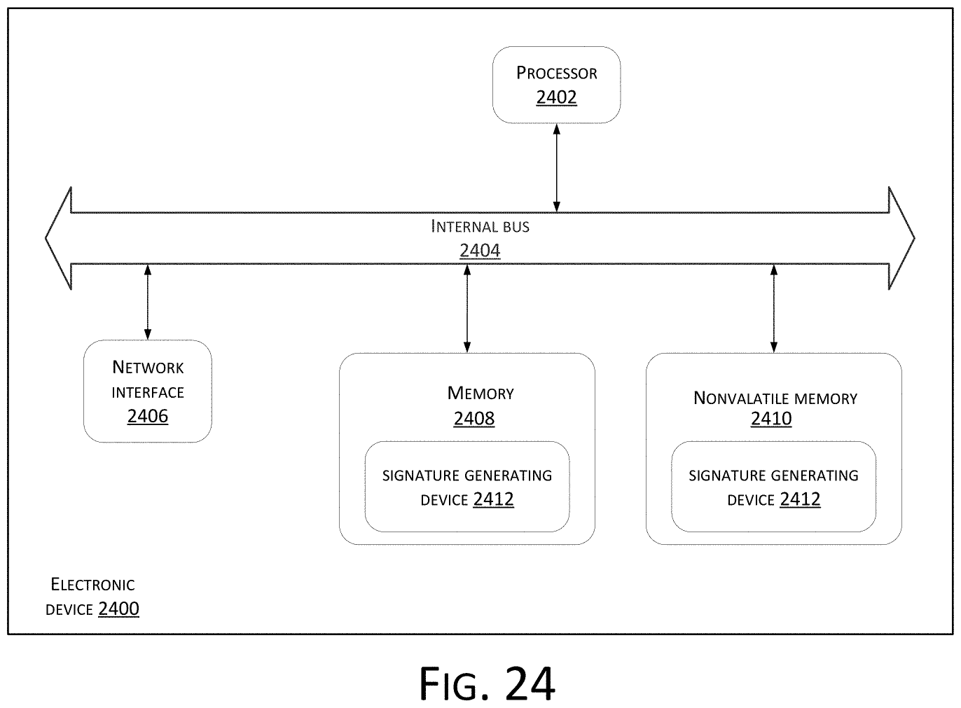

FIG. 24 is a schematic structural diagram of an electronic device according to an example embodiment. Referring to FIG. 24, at the hardware level, the electronic device 2400 includes a processor 2402, an internal bus 2404, a network interface 2406, a memory 2408, and a non-volatile memory 2410, and certainly may further include hardware required by other services. The processor 2402 reads a corresponding computer program from the non-volatile memory 2410 to the memory 2408 for running, which forms a signature generating device 2412 at the logical level. Certainly, in addition to the software implementation manner, other implementation manners, such as logic devices or a combination of software and hardware, etc., are not excluded in one or more example embodiments of this disclosure. In other words, the following processing procedure may be performed not only by various logic units, but also may be performed by hardware or logic devices.

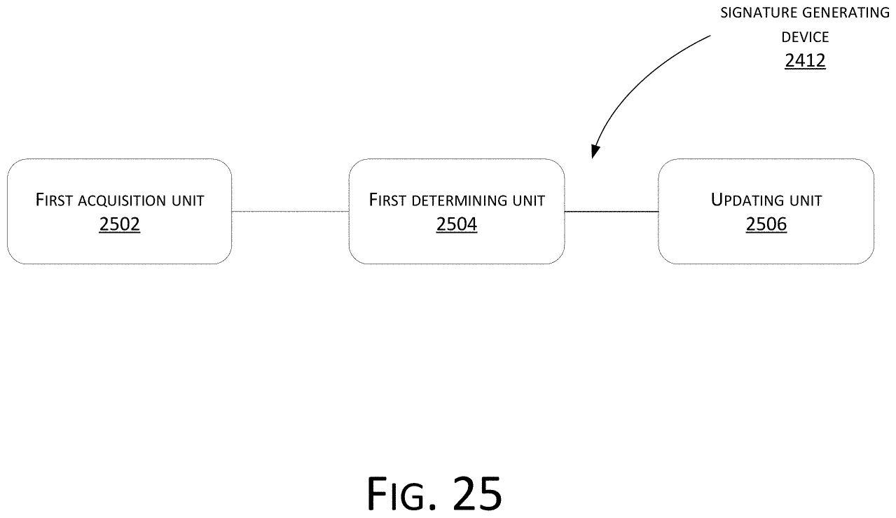

Referring to FIG. 25, in a software implementation manner, the signature generating device 2412 may include:

a first acquisition unit 2502 configured to acquire a signature template used by a user; and

a first determining unit 2504 configured to determine, according to contact information of the user, information content corresponding to an information item comprised in the signature template to generate a signature of the user.

For example, the signature generating device 2412 may further includes:

an updating unit 2506 configured to, when the information content corresponding to the information item in the contact information of the user is changed, update the signature of the user according to the changed contact information.

For example, the signature template includes a unified template for all members in a group to which the user belongs.

For example, the signature template includes at least one of the following information items: a personal information item corresponding to a personal information dimension and a group information item corresponding to a group information dimension.

For example, when the signature template includes the group information item, the signature of the user includes group information of the group to which the user belongs, and the group information is configured to be linked to an associated presentation interface of the group to which the user belongs.

For example, the signature of the user includes: an e-mail signature of the user.

For example, the signature of the user includes: a detail presentation mode applicable to a first scenario and a summary presentation mode applicable to a second scenario.

For example, the first scenario includes at least one of the following: a new communication message generation scenario and an inter-group communication scenario; and the second scenario includes at least one of the following: a communication message reply scenario and an intra-group communication scenario.

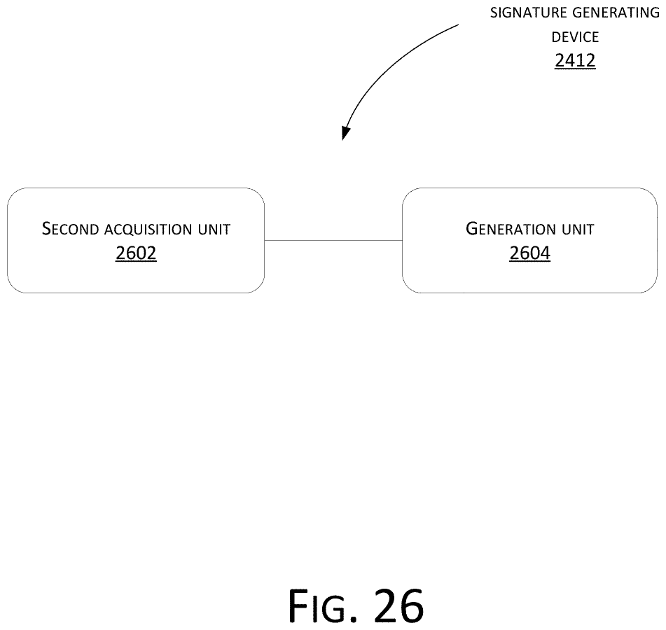

Referring to FIG. 26, in a software implementation manner, the signature generating device 2412 may include:

a second acquisition unit 2602 configured to acquire, according to a group to which a user belongs, a unified signature template of the group; and

a generation unit 2604 configured to generate a signature of the user according to the unified signature template.

For example, the unified signature template is configured by an administrator of the group.

For example, the generation unit 2604 is specifically configured to:

determine, according to contact information of the user, information content corresponding to an information item comprised in the unified signature template to generate the signature of the user.

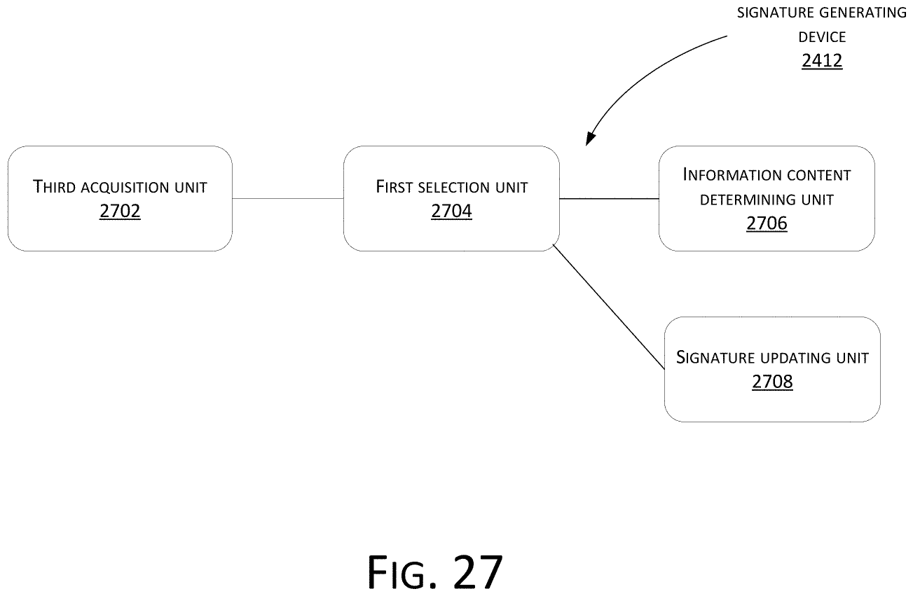

Referring to FIG. 27, in a software implementation manner, the signature generating device 2412 may include:

a third acquisition module 2702 configured to acquire alternative signature templates applicable to a user; and

a first selection module 2704 configured to select at least one signature template from the alternative signature templates for generating a signature of the user according to the selected signature template.

For example, the alternative signature templates include at least one of the following:

a unified signature template of a group to which the user belongs, a customized template configured by the user, and a shared template from another user or group.

For example, the alternative signature templates include a unified template for all members in the group to which the user belongs.

For example, the alternative signature templates include at least one of the following information items: a personal information item corresponding to a personal information dimension and a group information item corresponding to a group information dimension.

For example, the device further includes:

an information content determining unit 2706 configured to determine, according to contact information of the user, information content corresponding to the information item to generate a signature of the user.

For example, the device further includes:

a signature updating unit 2708 configured to, when the information content corresponding to the information item in the contact information of the user is changed, update the signature of the user according to the changed contact information.

For example, when the alternative signature templates include the group information item, the signature of the user includes group information of the group to which the user belongs, and the group information is configured to be linked to an associated presentation interface of the group to which the user belongs.

For example, the signature of the user includes: an e-mail signature of the user.

For example, the signature of the user includes: a detail presentation mode applicable to a first scenario and a summary presentation mode applicable to a second scenario.

For example,

the first scenario includes at least one of the following: a new communication message generation scenario and an inter-group communication scenario; and

the second scenario includes at least one of the following: a communication message reply scenario and an intra-group communication scenario.

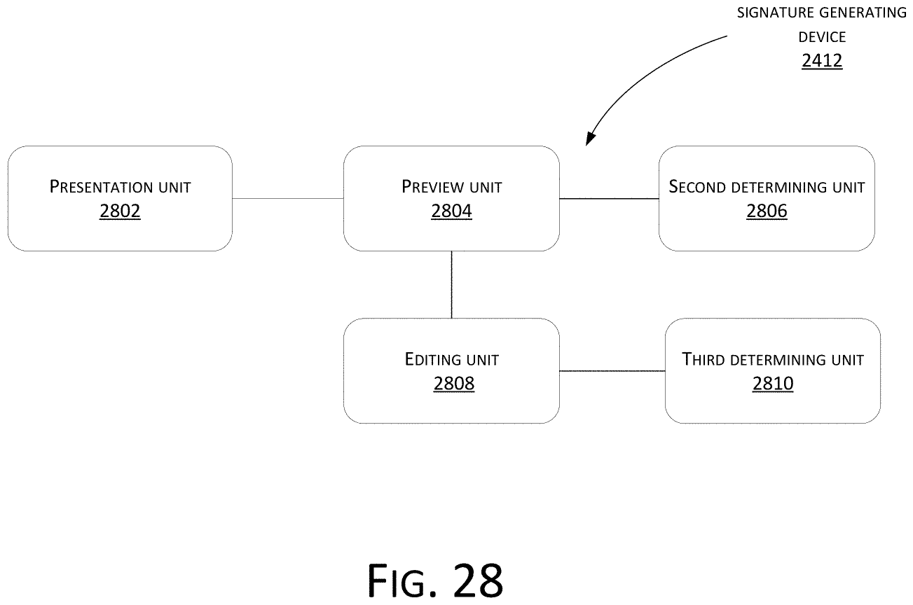

Referring to FIG. 28, in a software implementation manner, the signature generating device may include:

a presentation unit 2802 configured to present alternative signature templates applicable to a user;

a preview unit 2804 configured to present preview information of a signature of the user according to information items included in the alternative signature templates and contact information of the user; and

a second determining unit 2806 configured to determine a signature template selected by the user from the alternative signature templates for generating the signature of the user according to the selected signature template and the contact information of the user.

For example, the device further includes:

an editing unit 2808 configured to obtain an edited signature according to an editing operation of the user on the preview information; and

a third determining unit 2810 configured to determine the edited signature as the signature of the user when the selected signature template corresponds to the preview information.

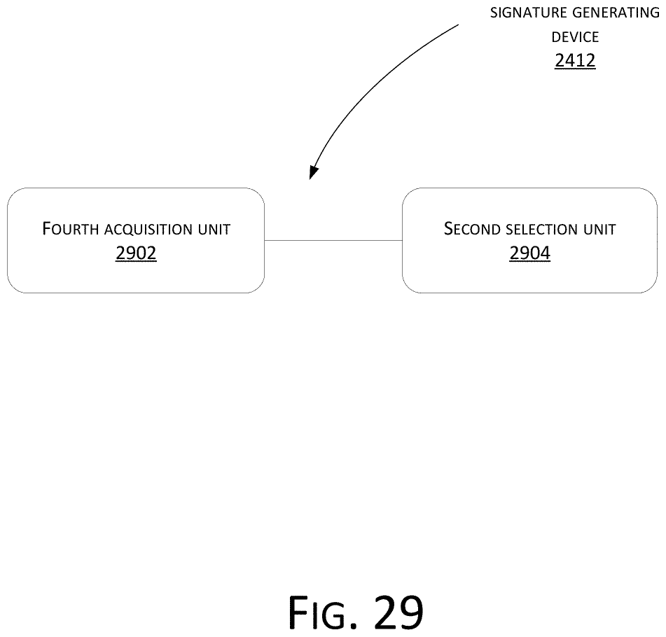

Referring to FIG. 29, in a software implementation manner, the signature generating device may include:

a fourth acquisition unit 2902 configured to acquire alternative signature templates applicable to a group; and

a second selection unit 2904 configured to select at least one signature template from the alternative signature templates for using the selected signature template as a unified template for group members of the group, the unified template being configured to generate signatures of the group members.

For example, the alternative signature templates include at least one of the following:

a customized template, and a shared template from a user or another group.

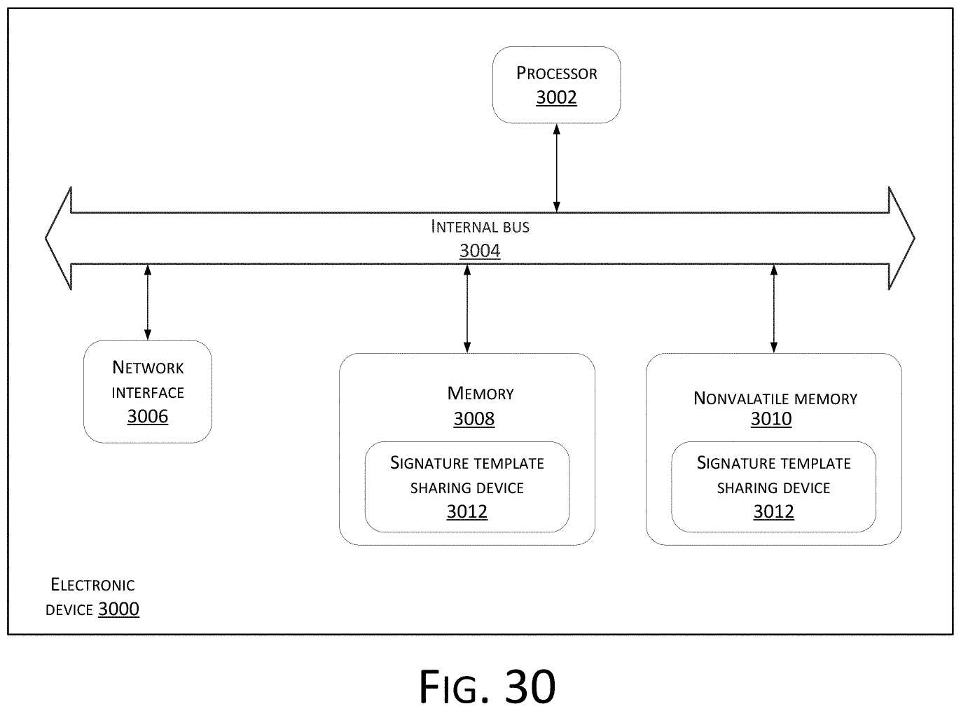

FIG. 30 is a schematic structural diagram of another electronic device according to an example embodiment. Referring to FIG. 30, at the hardware level, the electronic device 3000 includes a processor 3002, an internal bus 3004, a network interface 3006, a memory 3008, and a non-volatile memory 3010, and certainly may further include hardware required by other services. The processor 3002 reads a corresponding computer program from the non-volatile memory 3010 to the memory 3008 for running, which forms a signature template sharing device 3012 at the logical level. Certainly, in addition to the software implementation manner, other implementation manners, such as logic devices or a combination of software and hardware, etc., are not excluded in one or more example embodiments of this disclosure. In other words, the following processing procedure may be performed not only by various logic units, but also may be performed by hardware or logic devices.

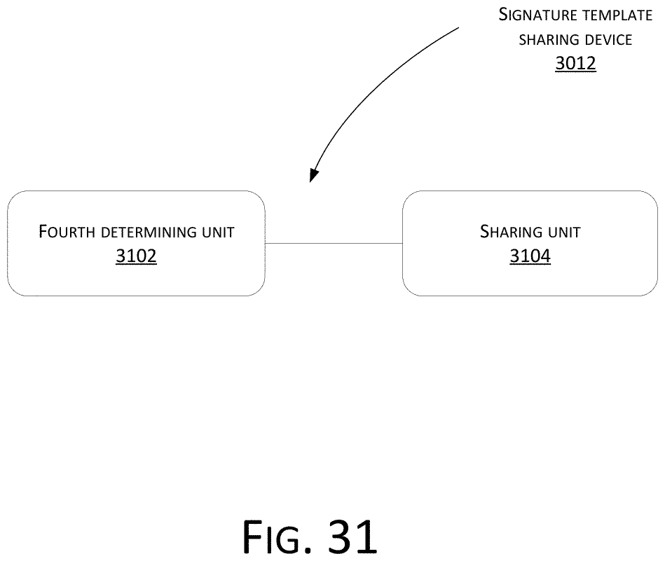

Referring to FIG. 31, in a software implementation manner, the signature template sharing device 3012 may include:

a fourth determining unit 3102 configured to determine a signature template used by a group; and

a sharing unit 3104 configured to share the signature template to another group for generating a corresponding signature by a group member in the another group according to the signature template.

The system, device, module or unit illustrated in the above example embodiments may be implemented specifically by a computer chip or an entity, or by a product having a certain function. A typical implementation device is a computer. For example, the computer may be specifically in the form of a personal computer, a laptop computer, a cellular phone, a camera phone, a smart phone, a personal digital assistant, a media player, a navigation device, an e-mail sending and receiving device, a game console, a tablet computer, a wearable device, or a combination of any of these devices.

In a typical configuration, the computer includes one or more central processing units (CPUs), an input/output interface, a network interface, and a memory.

The memory may include computer readable media such as a volatile memory, a Random-Access Memory (RAM), and/or non-volatile memory, e.g., a Read-Only Memory (ROM) or a flash RAM. The memory is an example of a computer readable medium.

The computer readable medium includes non-volatile and volatile media as well as movable and non-movable media and may implement information storage by means of any method or technology. The information may be a computer readable instruction, a data structure, and a module of a program or other data. Examples of the storage medium of a computer include, but are not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a magnetic cassette tape, a magnetic disk storage, a quantum memory, a graphene-based storage medium or other magnetic storage devices, or any other non-transmission medium, and may be used to store information accessible to the computing device. According to the definition in this text, the computer readable medium does not include transitory media, such as a modulated data signal and a carrier.

It should be further noted that the terms “include,” “comprise” or other variations thereof are intended to cover non-exclusive inclusion, so that a process, method, commodity or device including a series of elements not only includes the elements, but also includes other elements not clearly listed, or further includes elements inherent to the process, method, commodity or device. In the absence of more limitations, an element defined by “including a/an . . . ” does not exclude that the process, method, commodity or device including the element further has other identical elements.

Specific example embodiments of this disclosure are described above. Other example embodiments are within the scope of the appended claims. In some cases, the actions or steps recited in the claims may be executed in an order different from that in the example embodiments and still achieve a desired result. In addition, the process depicted in the accompanying drawings does not necessarily require that the desired result may be achieved only in the specific or sequential sequence shown. Multitasking and parallel processing may be feasible or beneficial in some implementation manners.

Terms used in one or more example embodiments of this disclosure are merely used for describing specific example embodiments, instead of limiting the one or more example embodiments of this disclosure. Singular forms “a(n),” “said,” and “the” used in one or more example embodiments of this disclosure and the appended claims also include plural forms, unless clearly specified in the context that other meanings are denoted. It should be further understood that the term “and/or” used in this text refers to and includes any or all possible combinations of one or more associated items listed.

It should be understood that although terms such as “first,” “second,” and “third” may be used to describe various kinds of information in one or more example embodiments of this disclosure, these kinds of information should not be limited to the terms. These terms are merely used to distinguish information of the same type from each other. For example, without departing from the scope of one or more example embodiments of this disclosure, the first information may also be referred to as second information, and similarly, the second information may also be referred to as first information. Depending on the context, the word “if” used in this text may be explained as “when . . . ,” “as . . . ,” or “in response to the determination.”

The above description is merely example embodiments of one or more example embodiments of this disclosure and is not used to limit the one or more example embodiments of this disclosure. Any modification, equivalent replacement, improvement and the like made within the spirit and principle of the one or more example embodiments of this disclosure should be included in the protection scope of the one or more example embodiments of this disclosure.

The present disclosure may further be understood with clauses as follows.

Clause 1. A signature generating method, comprising:

acquiring a signature template used by a user; and

determining, according to contact information of the user, information content corresponding to an information item comprised in the signature template to generate a signature of the user.

Clause 2. The method of clause 1, further comprising:

when the information content corresponding to the information item in the contact information of the user is changed, updating the signature of the user according to the changed contact information.

Clause 3. The method of clause 1, wherein the signature template comprises a unified template for all members in a group to which the user belongs.

Clause 4. The method of clause 1, wherein the signature template comprises at least one of the following information items: a personal information item corresponding to a personal information dimension and a group information item corresponding to a group information dimension.

Clause 5. The method of clause 4, wherein when the signature template comprises the group information item, the signature of the user comprises group information of the group to which the user belongs, and the group information is configured to be linked to an associated presentation interface of the group to which the user belongs.

Clause 6. The method of clause 1, wherein the signature of the user comprises an e-mail signature of the user.

Clause 7. The method of clause 1, wherein the signature of the user comprises: a detail presentation mode applicable to a first scenario and a summary presentation mode applicable to a second scenario.

Clause 8. The method of clause 7, wherein

the first scenario comprises at least one of the following: anew communication message generation scenario and an inter-group communication scenario; and

the second scenario comprises at least one of the following: a communication message reply scenario and an intra-group communication scenario.

Clause 9. A signature generating method, comprising:

acquiring, according to a group to which a user belongs, a unified signature template of the group; and

generating a signature of the user according to the unified signature template.

Clause 10. The method of clause 9, wherein the unified signature template is configured by an administrator of the group.

Clause 11. The method of clause 9, wherein the generating the signature of the user according to the unified signature template comprises:

determining, according to contact information of the user, information content corresponding to an information item comprised in the unified signature template to generate the signature of the user.

Clause 12. A signature generating method, comprising:

acquiring alternative signature templates applicable to a user; and

selecting at least one signature template from the alternative signature templates to generate a signature of the user according to the selected signature template.

Clause 13. The method of clause 12, wherein the alternative signature templates comprise at least one of the following:

a unified signature template of a group to which the user belongs;

a customized template configured by the user; and

a shared template from another user or group.

Clause 14. A signature generating method, comprising:

presenting alternative signature templates applicable to a user;

presenting preview information of a signature of the user according to information items comprised in the alternative signature templates and contact information of the user; and

determining a signature template selected by the user from the alternative signature templates to generate the signature of the user according to the selected signature template and the contact information of the user.

Clause 15. The method of clause 14, further comprising:

obtaining an edited signature according to an editing operation of the user on the preview information; and

determining the edited signature as the signature of the user when the selected signature template corresponds to the preview information.

Clause 16. A signature generating method, comprising:

acquiring alternative signature templates applicable to a group; and

selecting at least one signature template from the alternative signature templates to use the selected signature template as a unified template for group members of the group, the unified template being configured to generate signatures of the group members.

Clause 17. The method of clause 16, wherein the alternative signature templates comprise at least one of the following:

a customized template; and

a shared template from a user or another group.

Clause 18. A signature template sharing method, comprising:

determining a signature template used by a group; and

sharing the signature template to another group to generate a corresponding signature by a group member in the another group according to the signature template.

Clause 19. A signature generating device, comprising:

a first acquisition unit configured to acquire a signature template used by a user; and

a first determining unit configured to determine, according to contact information of the user, information content corresponding to an information item comprised in the signature template to generate a signature of the user.

Clause 20. The device of clause 19, further comprising:

an updating unit configured to, when the information content corresponding to the information item in the contact information of the user is changed, update the signature of the user according to the changed contact information.

Clause 21. The device of clause 19, wherein the signature template comprises a unified template for all members in a group to which the user belongs.

Clause 22. The device of clause 19, wherein the signature template comprises at least one of the following information items:

a personal information item corresponding to a personal information dimension; and

a group information item corresponding to a group information dimension.

Clause 23. The device of clause 22, wherein when the signature template comprises the group information item, the signature of the user comprises group information of the group to which the user belongs, and the group information is configured to be linked to an associated presentation interface of the group to which the user belongs.

Clause 24. The device of clause 19, wherein the signature of the user comprises an e-mail signature of the user.

Clause 25. The device of clause 19, wherein the signature of the user comprises: a detail presentation mode applicable to a first scenario and a summary presentation mode applicable to a second scenario.

Clause 26. The device of clause 25, wherein

the first scenario comprises at least one of the following: anew communication message generation scenario and an inter-group communication scenario; and

the second scenario comprises at least one of the following: a communication message reply scenario and an intra-group communication scenario.

Clause 27. A signature generating device, comprising:

a second acquisition unit configured to acquire, according to a group to which a user belongs, a unified signature template of the group; and

a generation unit configured to generate a signature of the user according to the unified signature template.

Clause 28. The device of clause 27, wherein the unified signature template is configured by an administrator of the group.

Clause 29. The device of clause 27, wherein the generation unit is specifically configured to:

determine, according to contact information of the user, information content corresponding to an information item comprised in the unified signature template to generate the signature of the user.

Clause 30. A signature generating device, comprising:

a third acquisition module configured to acquire alternative signature templates applicable to a user; and

a first selection module configured to select at least one signature template from the alternative signature templates to generate a signature of the user according to the selected signature template.

Clause 31. The device of clause 30, wherein the alternative signature templates comprise at least one of the following:

a unified signature template of a group to which the user belongs;

a customized template configured by the user; and

a shared template from another user or group.

Clause 32. A signature generating device, comprising:

a presentation unit configured to present alternative signature templates applicable to a user;

a preview unit configured to present preview information of a signature of the user according to information items comprised in the alternative signature templates and contact information of the user; and

a second determining unit configured to determine a signature template selected by the user from the alternative signature templates to generate the signature of the user according to the selected signature template and the contact information of the user.

Clause 33. The device of clause 32, further comprising:

an editing unit configured to obtain an edited signature according to an editing operation of the user on the preview information; and

a third determining unit configured to determine the edited signature as the signature of the user when the selected signature template corresponds to the preview information.

Clause 34. A signature generating device, comprising:

a fourth acquisition unit configured to acquire alternative signature templates applicable to a group; and

a second selection unit configured to select at least one signature template from the alternative signature templates to use the selected signature template as a unified template for group members of the group, the unified template being configured to generate signatures of the group members.

Clause 35. The device of clause 34, wherein the alternative signature templates comprise at least one of the following:

a customized template; and

a shared template from a user or another group.

Clause 36. A signature template sharing device, comprising:

a fourth determining unit configured to determine a signature template used by a group; and

a sharing unit configured to share the signature template to another group to generate a corresponding signature by a group member in the another group according to the signature template.

What is claimed is:

1. A method comprising:
acquiring a signature template used by a user; and
determining, according to contact information of the user, information content corresponding to an information item comprised in the signature template to generate a signature of the user.

2. The method of claim 1, further comprising:
determining that the information content corresponding to the information item in the contact information of the user is changed; and
updating the signature of the user according to the changed contact information.

3. The method of claim 1, wherein the signature template comprises a unified template for multiple members in a group to which the user belongs.

4. The method of claim 1, wherein the signature template comprises at least one of the following information items:
a personal information item corresponding to a personal information dimension; and
a group information item corresponding to a group information dimension.

5. The method of claim 4, further comprising:
determining that the signature template comprises the group information item;
including group information of the group to which the user belongs in the signature of the user; and
linking the group information to an associated presentation interface of the group to which the user belongs.

6. The method of claim 1, wherein the signature of the user comprises an e-mail signature of the user.

7. The method of claim 1, wherein the signature of the user comprises a detail presentation mode applicable to a first scenario.

8. The method of claim 7, wherein the first scenario comprises a new communication message generation scenario.

9. The method of claim 7, wherein the first scenario comprises an inter-group communication scenario.

10. The method of claim 1, wherein the signature of the user comprises a summary presentation mode applicable to a second scenario.

11. The method of claim 10, wherein the second scenario comprises a communication message reply scenario.

12. The method of claim 11, wherein the second scenario comprises an intra-group communication scenario.

13. An electronic device comprising:
one or more processors; and
one or more memories storing computer readable instructions that, executable by the one or more processors, cause the one or more processors to perform acts comprising:
acquiring, according to a group to which a user belongs, a unified signature template of the group; and
generating a signature of the user according to the unified signature template.

14. The electronic device of claim 13, wherein the unified signature template is configured by an administrator of the group.

15. The electronic device of claim 13, wherein the generating the signature of the user according to the unified signature template comprises:
determining, according to contact information of the user, information content corresponding to an information item comprised in the unified signature template to generate the signature of the user.

16. One or more memories storing computer readable instructions that, executable by one or more processors, cause the one or more processors to perform acts comprising:
presenting alternative signature templates applicable to a user;
presenting preview information of a signature of the user according to information items comprised in the alternative signature templates and contact information of the user;
receiving a selection that determines a signature template selected by the user from the alternative signature templates; and
generating the signature of the user according to the selected signature template and the contact information of the user.

17. The one or more memories of claim 16, wherein the acts further comprise:
obtaining an edited signature according to an editing operation of the user on the preview information; and
determining the edited signature as the signature of the user when the selected signature template corresponds to the preview information.

18. The one or more memories of claim 16, wherein the alternative signature templates comprise a customized template.

19. The one or more memories of claim 16, wherein the alternative signature templates comprise a shared template from a user or another group.

20. The one or more memories of claim 16, wherein the acts further comprise:
determining a signature template used by a group to which the user belongs; and
sharing the signature template to another group to generate a corresponding signature by a group member in the another group according to the signature template.
